(19) United States
(12) Patent Application Publication
(10) Pub. No.: US 2023/0000079 A1
(43) Pub. Date: Jan. 5, 2023

(54) COMBINATION COMPRISING A TRIKETONE HERBICIDE AND A DIPHENYLETHER HERBICIDE, AND A METHOD FOR MAKING AND USING THE COMBINATION

(71) Applicant: Generic Crop Science LLC, Henderson, NV (US)

(72) Inventors: Shiv Sharma, Houston, TX (US); Joe Middione, JR., Henderson, NV (US); Samuel Robert McClinton, Henderson, NV (US)

(73) Assignee: Generic Crop Science LLC, Henderson, NV (US)

(21) Appl. No.: 17/841,367

(22) Filed: Jun. 15, 2022

Related U.S. Application Data
(60) Provisional application No. 63/211,959, filed on Jun. 17, 2021.

(51) Int. Cl. A01N 41/10; A01N 35/06; A01P 13/00

(52) U.S. Cl. CPC A01N 41/10; A01N 35/06; A01P 13/00

(57) ABSTRACT

Disclosed embodiments of the present invention concern an herbicidal combination, such as a premix concentrate or a tank mix, comprising 1% to 10% of a triketone herbicide, such as a benzoylcyclohexane-1,3-dione, and 30% to 50% of a diphenylether herbicide, such as a 2-chloro-4-(trifluoromethyl)phenoxy]-2-nitrobenzoic acid. Certain embodiments comprise, consist of, or consist essentially of, mesotrione and oxyfluorfen. Particular compositions comprise an aqueous composition comprising oxyfluorfen, mesotrione, a surfactant, a freeze/thaw agent, a defoaming agent, a rheology agent, and an antimicrobial agent. A method for using disclosed combinations comprises applying a combination to a locus where undesired vegetation is present or may be present. Yet another embodiment comprises a method for forming a disclosed combination, such as a premix concentrate or a tank mix, comprising, consisting of, or consisting essentially of, (1) a triketone herbicide, such as mesotrione, and (2) a diphenylether herbicide, such as oxyfluorfen.

### CROSS REFERENCE TO RELATED APPLICATION

This application claims the benefit of the earlier filing date of U.S. provisional patent application No. 63/211,959, filed on Jun. 17, 2021, which is incorporated herein by reference in its entirety.

### FIELD

This application concerns embodiments of an herbicidal combination, with particular embodiments concerning an aqueous premix concentrate composition, comprising a triketone herbicide, such as mesotrione or analogs thereof, and a diphenylether herbicide, such as oxyfluorfen or analogs thereof, and a method for making and using the combination.

### BACKGROUND

Mesotrione, 2-[4-(methylsulfonyl)-2-nitrobenzoyl]cyclohexane-1,3-dione, is used as a selective herbicide, and is particularly suitable for controlling undesired vegetation in a maize locus. Mesotrione is a 4-hydroxyphenylpyruvate dioxygenase inhibitor, and a member of the triketone-class of herbicides, as can be seen from the following structure.

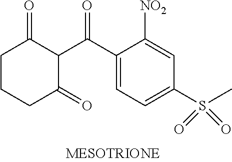 [SMILES: CS(=O)(=O)c1ccc(C(=O)C2C(=O)CCCC2=O)c([N+](=O)[O-])c1]

Triketone herbicides effectively control a wide range of commercially-important weed species both pre- and post-emergence. Mesotrione controls a wide range of broad-leaved weeds that compete with maize and specialty crops. Mesotrione can also suppress certain annual grass weeds that may be present in the crop. Mesotrione's selectivity is understood to be based on its greater potency on a target enzyme in dicotyledons relative to monocotyledons. Moreover, maize can metabolize the dione-containing ring. Mesotrione often is formulated as a suspension concentrate, and has a water solubility of 1,500 mg/L at 20° C.

Oxyfluorfen, 2-chloro-4-(trifluoromethyl)phenyl 3-ethoxy-4-nitrophenyl ether, is a selective pre- and post-emergent herbicide that is often used to control certain annual broadleaf and grassy weeds in vegetables, tree fruit, cotton, ornamentals, and on non-crop areas (e.g. rail and highway right-of-ways). Oxyfluorfen typically is used as an emulsifiable concentrate or granular formulation. The structural formula for oxyfluorfen is provided below.

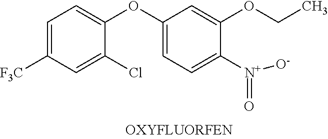 [SMILES: CCOc1cc(Oc2ccc(C(F)(F)F)cc2Cl)ccc1[N+](=O)[O-]]

Oxyfluorfen has a solubility of only 0.1 mg/L in water, but is highly soluble in most organic solvents.

### SUMMARY

Disclosed embodiments of the present invention provide a novel herbicidal combination, such as a composition, that includes at least two different herbicides particularly selected to have different, but compatible, biological modes of action. Certain disclosed embodiments concern an herbicidal combination comprising a triketone herbicide, such as a benzoylcyclohexane-1,3-dione, and a diphenylether herbicide, such as a 2-chloro-4-(trifluoromethyl)phenoxy]-2-nitrobenzoic acid. The combination typically is a composition, such as a premix concentrate. Certain embodiments comprise a triketone herbicide having a Formula 1

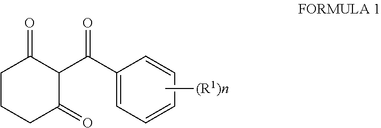

wherein R¹ is selected from halogen, preferably Cl, nitro (—NO₂), SO₂R² where R² is lower alkyl, more particularly C₁₋₆ alkyl, such as methyl, trihaloalkyl and trihaloalkoxy, and n=1, 2 or 3. For particular embodiments wherein the combination is a composition, R¹ is Cl, R² is methyl and n=2. In more particular embodiments, the triketone herbicide has a Formula 2

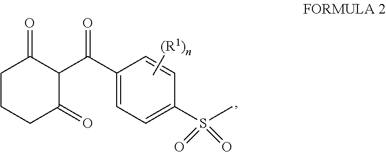

### or Formula 3

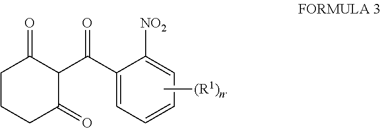

Exemplary suitable triketone herbicides can be selected from mesotrione, 2-[4-(methylsulfonyl)-2-nitrobenzoyl]cyclohexane-1,3-dione, nitisinone, 2-[2-nitro-4-(trifluoromethyl)benzoyl]-cyclohexane-1,3-dione, sulcotrione 2-(2-chloro-4-methylsulfonylbenzoyl)cyclohexane-1,3-dione, and tembotrione, 2-[2-chloro-4-methylsulfonyl-3-(2,2,2-trifluoroethoxymethyl)-benzoyl]cyclohexane-1,3-dione, with mesotrione being a currently preferred triketone herbicide.

Disclosed combinations also comprise a diphenylether herbicide having a Formula 4

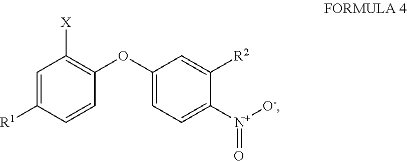

wherein R¹ is C₁₋₆ alkyl or C₁₋₆ haloalkyl, such as trifluoromethyl (—CF₃), X is halogen, such as Cl, R² is —CO₂H, or salts thereof, CO₂R³, where R³ is C₁₋₆ alkyl, ether, such as O—C₁₋₆ alkyl, with particular embodiments including ethyl ether (—OCH₂CH₃),

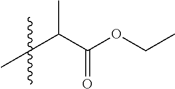 [SMILES: *C(C)C(=O)OCC]

or amidosulfonyl, such as

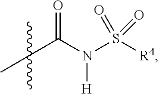

wherein R⁴ is C₁₋₆ alkyl, particularly methyl. The diphenylether herbicide may be selected from oxyfluorfen, 2-chloro-4-(trifluoromethyl)phenyl 3-ethoxy-4-nitrophenyl ether, acifluorfen, 5-[2-chloro-4-(trifluoromethyl)phenoxy]-2-nitrobenzoic acid, 5-[2-chloro-4-(trifluoromethyl)phenoxy]-N-methylsulfonyl-2-nitrobenzamide, and lactofen, 1-ethoxy-1-oxopropan-2-yl) 5-[2-chloro-4-(trifluoromethyl)phenoxy]-2-nitrobenzoate, with oxyfluorfen being a currently preferred diphenylether herbicide. Particular embodiments comprise mesotrione and oxyfluorfen, and even more particularly concern compositions that, with reference solely to the active technical component, consist essentially of mesotrione and oxyfluorfen.

A person of ordinary skill in the art will appreciate that disclosed combinations comprising a triketone herbicide and a diphenylether herbicide may further comprise additional components that are generally suitable for forming useful herbicidal compositions. These additional components include, by way of example and without limitation, an anionic surface active agent, an antifoaming/defoaming agent, an anti-freeze agent, a cationic surface active agent, a co-herbicide, a dispersing agent, a filler, a fertilizer, a liquid carrier, a non-ionic surface active agent, a microbiocidal agent, a pH adjustor, a preservative, a rheology aid, a safener, a solid carrier, a solvent, a co-solvent, a spray additive, a surfactant, a suspending agent, a wetting agent, and any and all combinations thereof. For embodiments comprising a co-herbicide, such co-herbicide may be, by way of example and without limitation, a lipid biosynthesis inhibitor, an ALS inhibitor, a photosynthesis inhibitor, a protoporphyrinogen-IX-oxidase inhibitor, a bleacher-herbicide based on inhibition of carotenoid biosynthesis, an EPSP synthase inhibitor, a glutamine synthetase inhibitor, a DHP synthase inhibitor, a mitosis inhibitor, a VLCFA inhibitor based on inhibiting synthesis of long chain fatty acids, a cellulose biosynthesis inhibitor, a de-coupler herbicide based on disrupting cell membranes, an auxinic herbicide, and an auxin transport inhibitor.

Disclosed combinations may comprise varying amounts of diphenylether herbicide relative to the triketone herbicide. For example, certain embodiments comprise 5 to 10 parts by weight of the diphenylether herbicide relative to the triketone herbicide, more typically 7 parts to 9 parts by weight of the diphenylether herbicide relative to the triketone herbicide, with one particular embodiment comprising 8.3:1 diphenylether herbicide to triketone herbicide. For compositions, and with reference to weight percentages relative to all components in the composition, certain disclosed embodiments comprise 30% to 50% diphenylether herbicide and 1% to 10% triketone herbicide, more typically 35%-40% diphenylether herbicide and 2%-5% triketone herbicide. One particular disclosed embodiment comprised 38%-39% oxyfluorfen relative to the weight sum of all components comprising the composition, and 4%-5% mesotrione relative to the weight sum of all components comprising the composition. With reference to application rates, disclosed combinations typically are used at an application rate of 45 fluid ounces to 50 fluid ounces of the diphenylether herbicide per acre treated and 4 fluid ounces to 10 fluid ounces of the triketone herbicide per acre treated. For example, a particular combination used 48 fluid ounces to 50 fluid ounces of oxyfluorfen per acre treated and 4 fluid ounces to 6 fluid ounces of mesotrione per acre treated.

Particular embodiments may be formulated as a concentrated premix. The concentrated premix may be diluted by an end user to form an aqueous and/or an organic diluted product for application to a locus comprising unwanted vegetation.

A particular embodiment according to the present invention was formulated as an aqueous premix composition, comprising, by weight percent, 38%-39% oxyfluorfen, 4%-5% mesotrione, 3% surfactant, 12% freeze/thaw agent, 0.2% defoaming agent, 0.1% rheology agent, and 0.1% antimicrobial agent. Another particular disclosed embodiment consists essentially of 1% to 10% mesotrione and 30% to 50% oxyfluorfen.

A method for using disclosed combinations also is provided. The method involves applying a disclosed combination to a locus where undesired vegetation is present or may be present. The method may involve using a premix concentrate, a diluted premix concentrate, or a tank mix composition, comprising (1) mesotrione, and (2) oxyfluorfen, and more particularly a composition that consists essentially of (1) mesotrione, and (2) oxyfluorfen.

Yet another embodiment comprises a method for forming a disclosed combination, such as a premix concentrate, comprising an effective amount of (1) a triketone herbicide, such as mesotrione, and (2) a diphenylether herbicide, such as oxyfluorfen. Particular such compositions comprise an aqueous composition comprising oxyfluorfen, mesotrione, a surfactant, a freeze/thaw agent, a defoaming agent, a rheology agent, an antimicrobial agent. The method may comprise forming a composition that, with reference solely to the active technical, consists essentially of (1) mesotrione, and (2) oxyfluorfen.

### BRIEF DESCRIPTION OF THE DRAWING

FIG. 1 is a table showing weed control provided by mesotrione relative to two oxyfluorfen compositions.

FIG. 2 is a graph of % weed control versus treatment providing results obtained according to Example 4 7 days after initial treatment illustrating weed control for a control with no herbicidal application, mesotrione as a solo application, oxyfluorfen as a solo treatment, a mesotrione+oxyfluorfen combination (6 fluid ounces+48 fluid ounces), a suspension concentrate of mesotrione+oxyfluorfen at 36 fluid ounces and a suspension concentrate of mesotrione+oxyfluorfen at 54 fluid ounces.

FIG. 3 is a graph of % weed control versus treatment providing results obtained according to Example 4 14 days after initial treatment illustrating weed control for a control with no herbicidal application, mesotrione as a solo application, oxyfluorfen as a solo treatment, a mesotrione+oxyfluorfen combination (6 fluid ounces+48 fluid ounces), a suspension concentrate of mesotrione+oxyfluorfen at 36 fluid ounces and a suspension concentrate of mesotrione+oxyfluorfen at 54 fluid ounces.

FIG. 4 is a graph of % weed control versus treatment providing results obtained according to Example 4 28 days after initial treatment illustrating weed control for a control with no herbicidal application, mesotrione as a solo application, oxyfluorfen as a solo treatment, a mesotrione+oxyfluorfen combination (6 fluid ounces+48 fluid ounces), a suspension concentrate of mesotrione+oxyfluorfen at 36 fluid ounces and a suspension concentrate of mesotrione+oxyfluorfen at 54 fluid ounces.

FIG. 5 is a graph of % weed control versus treatment providing results obtained according to Example 4 42 days after initial treatment illustrating weed control for a control with no herbicidal application, mesotrione as a solo application, oxyfluorfen as a solo treatment, a mesotrione+oxyfluorfen combination (6 fluid ounces+48 fluid ounces), a suspension concentrate of mesotrione+oxyfluorfen at 36 fluid ounces and a suspension concentrate of mesotrione+oxyfluorfen at 54 fluid ounces.

FIG. 6 is a graph of % weed control versus treatment providing results obtained according to Example 4 56 days after initial treatment illustrating weed control for a control with no herbicidal application, mesotrione as a solo application, oxyfluorfen as a solo treatment, a mesotrione+oxyfluorfen combination (6 fluid ounces+48 fluid ounces), a suspension concentrate of mesotrione+oxyfluorfen at 36 fluid ounces and a suspension concentrate of mesotrione+oxyfluorfen at 54 fluid ounces.

### DETAILED DESCRIPTION

### I. Definitions

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood by one of ordinary skill in the art to which this disclosure pertains. Although methods and materials similar or equivalent to those described herein can be used to practice or test disclosed subject matter, suitable methods and materials are described below. The materials, methods, and examples are illustrative only and are not intended to be limiting. Other features of the disclosure will be apparent to a person of ordinary skill in the art from the following detailed description and the claims.

The disclosure of numerical ranges includes written description for each and every discrete point within the range, inclusive of endpoints, unless otherwise noted.

Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods known to those of ordinary skill in the art. When directly and explicitly distinguishing embodiments from discussed prior art, the embodiment numbers are not approximates unless the word “about” is expressly recited.

Although alternatives for various components, parameters, operating conditions, etc., may be set forth herein, this does not mean that such alternatives are necessarily equivalent and/or perform equally well. Nor does it mean that the alternatives are listed in a preferred order unless stated otherwise.

In order to facilitate review of the various embodiments of the disclosure, the following explanations of specific terms are provided:

Acceptable salt: A compatible salt of a compound, such as a carboxylic acid, that can be that can be used for an intended pesticidal/herbicidal purpose, which salts are derived from a variety of organic and inorganic counter ions well known in the art and include, by way of example only, sodium, potassium, calcium, magnesium, ammonium, tetraalkylammonium, and the like; and when the molecule contains a basic functionality, salts of organic or inorganic acids, such as hydrochloride, hydrobromide, tartrate, mesylate, acetate, maleate, oxalate, and the like. Acceptable acid addition salts are those salts that retain the effectiveness of the free bases while formed by acid partners that are not biologically or otherwise undesirable, e.g., inorganic acids such as hydrochloric acid, hydrobromic acid, sulfuric acid, nitric acid, phosphoric acid, and the like, as well as organic acids such as acetic acid, trifluoroacetic acid, propionic acid, glycolic acid, pyruvic acid, oxalic acid, maleic acid, malonic acid, succinic acid, fumaric acid, tartaric acid, citric acid, benzoic acid, benzene sulfonic acid (besylate), cinnamic acid, mandelic acid, methanesulfonic acid, ethanesulfonic acid, p-toluenesulfonic acid, salicylic acid and the like. Acceptable base addition salts include those derived from inorganic bases such as sodium, potassium, lithium, ammonium, calcium, magnesium, iron, zinc, copper, manganese, aluminum salts and the like. Exemplary salts are the ammonium, potassium, sodium, calcium, and magnesium salts. Salts derived from organic non-toxic bases include, but are not limited to, salts of primary, secondary, and tertiary amines, substituted amines including naturally occurring substituted amines, cyclic amines and basic ion exchange resins, such as isopropylamine, trimethylamine, diethylamine, triethylamine, tripropylamine, ethanolamine, 2-dimethylaminoethanol, 2-diethylaminoethanol, dicyclohexylamine, lysine, arginine, histidine, caffeine, procaine, hydrabamine, choline, betaine, ethylenediamine, glucosamine, methylglucamine, theobromine, purines, piperazine, piperidine, N-ethylpiperidine, polyamine resins, and the like. Exemplary organic bases are isopropylamine, diethylamine, ethanolamine, trimethylamine, dicyclohexylamine, choline, and caffeine. (See, for example, S. M. Berge, et al., “Pharmaceutical Salts,” J. Pharm. Sci., 1977; 66:1-19, which is incorporated herein by reference.)

Aliphatic: A substantially hydrocarbon-based compound, or a radical thereof (e.g., C₆H₁₃, for a hexane radical), including alkanes, alkenes, alkynes, including cyclic versions thereof, and further including straight- and branched-chain arrangements, and all stereo and position isomers as well. Unless expressly stated otherwise, an aliphatic group contains from one to twenty-five carbon atoms (C₁-C₂₅); for example, from one to fifteen, from one to ten, from one to six, or from one to four carbon atoms. The term “lower aliphatic” refers to an aliphatic group containing from one to ten carbon atoms. An aliphatic chain may be substituted or unsubstituted. Unless expressly referred to as an “unsubstituted aliphatic,” an aliphatic group can either be unsubstituted or substituted. An aliphatic group can be substituted with one or more substituents (up to two substituents for each methylene carbon in an aliphatic chain, or up to one substituent for each carbon of a C═C double bond in an aliphatic chain, or up to one substituent for a carbon of a terminal methine group). Exemplary substituents include, but are not limited to, alkyl, alkenyl, alkynyl, alkoxy, alkylamino, alkylthio, acyl, aldehyde, amide, amino, aminoalkyl, aryl, arylalkyl, carboxyl, cyano, cycloalkyl, dialkylamino, halo, haloaliphatic, heteroaliphatic, heteroaryl, heterocycloaliphatic, hydroxyl, oxo, sulfonamide, sulfhydryl, thioalkoxy, or other functionality.

Alkoxy: A radical (or substituent) having the structure —OR, where R is a substituted or unsubstituted alkyl. Methoxy (OCH₃) is an exemplary alkoxy group. In a substituted alkoxy, R is alkyl substituted with a non-interfering substituent. “Thioalkoxy” refers to —S—R, where R is substituted or unsubstituted alkyl. “Haloalkyloxy” means a radical OR where R is a haloalkyl.

Alkyl: A hydrocarbon group having a saturated carbon chain. The chain may be cyclic, branched or unbranched. Examples, without limitation, of alkyl groups include methyl, ethyl, propyl, butyl, pentyl, hexyl, heptyl, octyl, nonyl and decyl. The term lower alkyl means the chain includes 1-10 carbon atoms. The terms alkenyl and alkynyl refer to hydrocarbon groups having carbon chains containing one or more double or triple bonds, respectively.

Alkylamino: A chemical functional group —N(H)R, where R is an alkyl group.

Alkylammonium: A cation having a formula [N(H)(R′)₃]+where each R′ independently is H or alkyl.

Amide: An organic compound characterized by a carbonyl group (C═0) linked to a nitrogen atom and having the following general formula, where R, R′ and R″ are the same or different, and typically are selected from hydrogen, aliphatic, and aryl.

Amido: A chemical functional group —C(O)N(R)(R′) where R and R′ are independently hydrogen, alkyl, heteroalkyl, haloalkyl, aliphatic, heteroaliphatic, aryl (such as optionally substituted phenyl or benzyl), heteroaryl, alkylsulfano, or other functionality.

Amino: A chemical functional group —N(R)R′ where R and R′ are independently hydrogen, alkyl, heteroalkyl, haloalkyl, aliphatic, heteroaliphatic, aryl (such as optionally substituted phenyl or benzyl), heteroaryl, alkylsulfano, or other functionality. A “primary amino” group is NH₂. “Mono substituted amino” means a radical —N(H)R substituted as above and includes, e.g., methylamino, (1-methylethyl)amino, phenylamino, and the like. “Di substituted amino” means a radical —N(R)R′ substituted as above and includes, e.g., dimethylamino, methylethylamino, di(1 methylethyl)amino, and the like.

Aralkyl/arylalkyl: An aryl group (such as a phenyl group) appended to an alkyl radical including, but not limited to, benzyl, ethylbenzene, propylbenzene, butylbenzene, pentylbenzene, and the like. Conversely the term “phenylalkyl” refers to a phenyl group appended to an alkyl radical. Aralkyl groups, such as benzyl groups, may be unsubstituted or substituted with one, two or three substituents, with substituent(s) independently selected from alkyl, heteroalkyl, aliphatic, heteroaliphatic, thioalkoxy, haloalkyl (such as CF₃), halo, nitro, cyano, OR (where R is hydrogen or alkyl), N(R)R′ (where R and R′ are independently of each other hydrogen or alkyl), COOR (where R is hydrogen or alkyl) or —C(O)N(R′)R″ (where R′ and R″ are independently selected from hydrogen or alkyl). Non limiting examples, include o, m, and/or p chlorobenzyl, o, m, and/or p methoxybenzyl, and o, m, and/or p (trifluoromethyl)benzyl.

Aromatic: Unsaturated, cyclic hydrocarbons having alternate single and double bonds. Benzene, a 6-carbon ring containing three double bonds, is a typical aromatic compound.

Aryl: A monovalent aromatic carbocyclic group of, unless specified otherwise, from 6 to 15 carbon atoms having a single ring (e.g., phenyl) or multiple condensed rings in which at least one ring is aromatic (e.g., quinoline, indole, benzodioxole, and the like), provided that the point of attachment is through an atom of an aromatic portion of the aryl group and the aromatic portion at the point of attachment contains only carbons in the aromatic ring. If any aromatic ring portion contains a heteroatom, the group is a heteroaryl and not an aryl. Aryl groups are monocyclic, bicyclic, tricyclic or tetracyclic.

Arylalkyl: An acyclic alkyl group in which one of the hydrogen atoms bonded to a carbon atom, typically a terminal or sp3 carbon atom, is replaced with an aryl group. Typical arylalkyl groups include, but are not limited to, benzyl, 2-phenylethan-1-yl, naphthylmethyl, 2-naphthylethan-1-yl, naphthobenzyl, 2-naphthophenylethan-1-yl and the like. Where specific alkyl moieties are intended, the nomenclature arylalkanyl, arylalkenyl and/or arylalkynyl may be used.

Carboxyalkyl: A functional group with the formula —COOR where R is alkyl.

Carboxyl: A COOH radical. Substituted carboxyl refers to COOR where R is aliphatic, heteroaliphatic, alkyl, heteroalkyl, or a carboxylic acid or ester.

Carboxylic Acid: A carbonyl-bearing functional group having a formula RCOOH where R is aliphatic, heteroaliphatic, alkyl, or heteroalkyl.

Combination: A combination comprises two or more active components that are used, such as being applied to a plant or plant locus, wherein the effective time period of the first component overlaps with the effective time period of the second and subsequent components. A combination may be a composition comprising the components, or it may be two or more individual components administered substantially simultaneously, or sequentially in any order

Derivative or Analog: A compound that is derived from a similar compound or a compound that can be imagined to arise from another compound, for example, if one atom or functional group is replaced with another atom or functional group.

Ester: A chemical compound derived from an organic acid (general formula: RCO₂H) where the hydrogen of the —OH (hydroxyl) group is replaced by virtually any group, including aliphatic, substituted aliphatic, aryl, arylalkyl, heteroaryl, etc.

Functional Group: A specific group of atoms within a molecule that is responsible for the characteristic chemical reactions of the molecule. Exemplary functional groups include, without limitation, alkyl, alkenyl, alkynyl, aryl, halo (fluoro, chloro, bromo, iodo), epoxide, hydroxyl, carbonyl (ketone), aldehyde, carbonate ester, carboxylate, carboxyl, ether, ester, peroxy, hydroperoxy, carboxamide, amino (primary, secondary, tertiary), ammonium, imide, azide, cyanate, isocyanate, thiocyanate, nitrate, nitrite, nitrile, nitroalkyl, nitroso, pyridyl, phosphate, sulfonyl, sulfide, thiol (sulfhydryl), disulfide.

Herbicide: an active ingredient that kills, controls or otherwise adversely modifies the growth of plants.

Herbicidally Effective or Vegetation Controlling Amount: An amount of an active ingredient which causes an adverse modifying effect to a plant, such as, deviations from natural development, including killing the plant, regulating plant growth, desiccating the plant, retarding plant growth, etc.

Lower: Refers to organic compounds having 10 or fewer carbon atoms (C₁₋₁₀) in a chain, including all branched and stereochemical variations, particularly including methyl, ethyl, propyl, butyl, pentyl, hexyl, heptyl, octyl, nonyl, and decyl.

Plants: includes germinant seeds, emerging seedlings, plants emerging from vegetative propagules, and established vegetation.

Substituent: An atom or group of atoms that replaces another atom in a molecule as the result of a reaction. The term “substituent” typically refers to an atom or group of atoms that replaces a hydrogen atom, or two hydrogen atoms if the substituent is attached via a double bond, on a parent hydrocarbon chain or ring. The term “substituent” may also cover groups of atoms having multiple points of attachment to the molecule, e.g., the substituent replaces two or more hydrogen atoms on a parent hydrocarbon chain or ring. In such instances, the substituent, unless otherwise specified, may be attached in any spatial orientation to the parent hydrocarbon chain or ring. Exemplary substituents include, for instance, alkyl, alkenyl, alkynyl, alkoxy, alkylamino, alkylthio, acyl, aldehyde, amido, amino, aminoalkyl, aryl, arylalkyl, arylamino, carbonate, carboxyl, cyano, cycloalkyl, dialkylamino, halo, haloaliphatic (e.g., haloalkyl), haloalkoxy, heteroaliphatic, heteroaryl, heterocycloaliphatic, hydroxyl, oxo, sulfonamide, sulfhydryl, thio, and thioalkoxy groups.

Substituted: A fundamental compound, such as an aryl or aliphatic compound, or a radical thereof, having coupled thereto one or more substituents, each substituent typically replacing a hydrogen atom on the fundamental compound. A person of ordinary skill in the art will recognize that compounds disclosed herein may be described with reference to particular structures and substituents coupled to such structures, and that such structures and/or substituents also can be further substituted, unless expressly stated otherwise or context dictates otherwise. Solely by way of example and without limitation, a substituted aryl compound may have an aliphatic group coupled to the closed ring of the aryl base, such as with toluene. Again solely by way of example and without limitation, a long-chain hydrocarbon may have a hydroxyl group bonded thereto.

%: Unless stated otherwise, all amounts stated herein concerning compositions and composition components according to the present invention are weight percents (wt. %).

Certain embodiments of the present invention concern a combination, and particularly a composition, comprising a mixture of a triketone herbicide and a diphenylether herbicide. Certain more particular embodiments of the present invention concern a binary composition, such as a composition that comprises, consists of, or consists essentially of, a triketone herbicide and a diphenylether herbicide. An even more particular embodiment concerns a combination that comprises, consists of, or consists essentially of, mesotrione and oxyfluorfen. As used in this context, consists of and consists essentially of are intended to refer to the active ingredient, also perhaps referred to in the field as the technical, that is used to form such compositions. That is, such terms are intended to limit certain disclosed compositions to just these particular active components, but other components typically used to form herbicidal compositions can be included, such as, solely by way of example and without limitation, adjuvants, surfactants, safeners, etc.

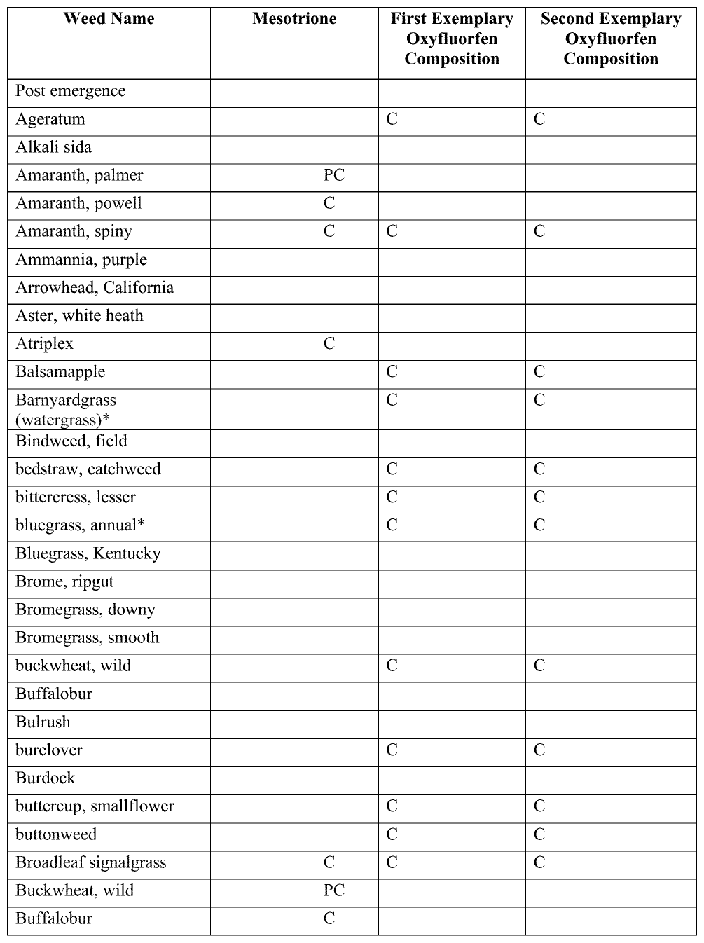

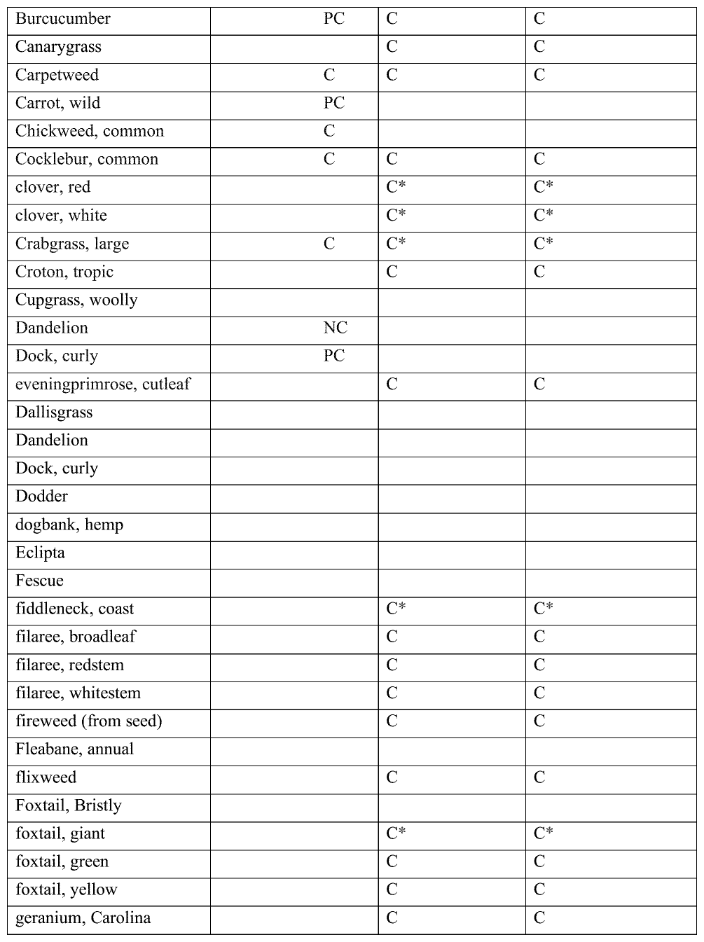

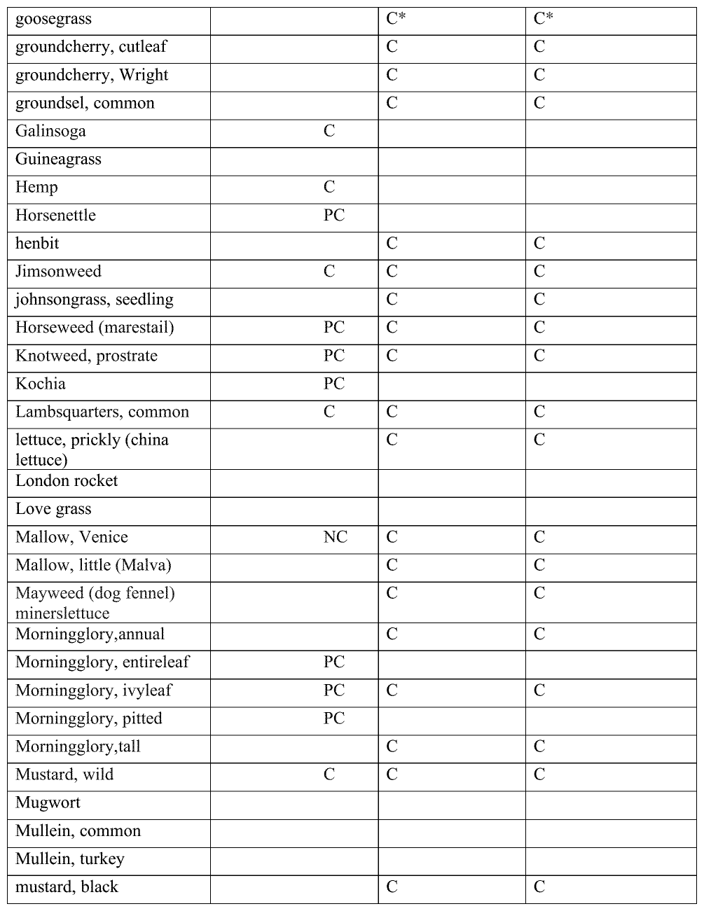

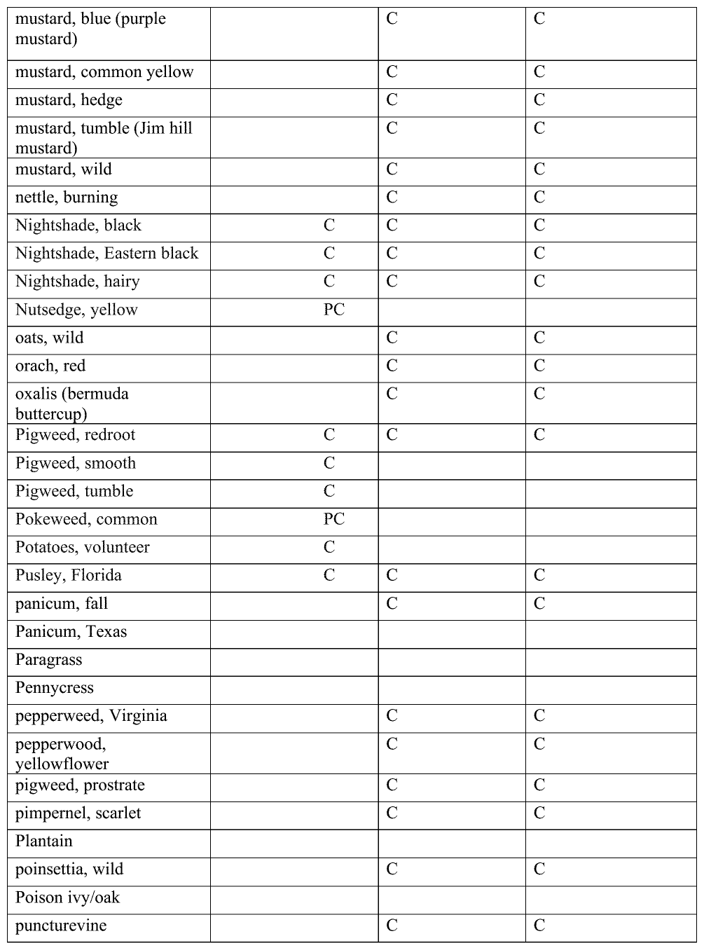

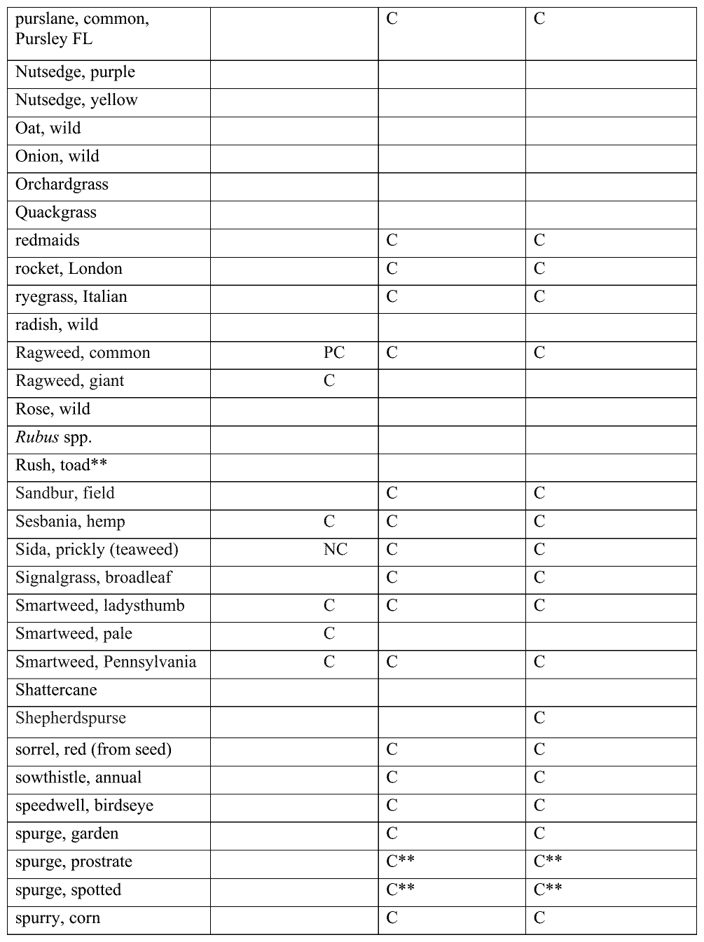

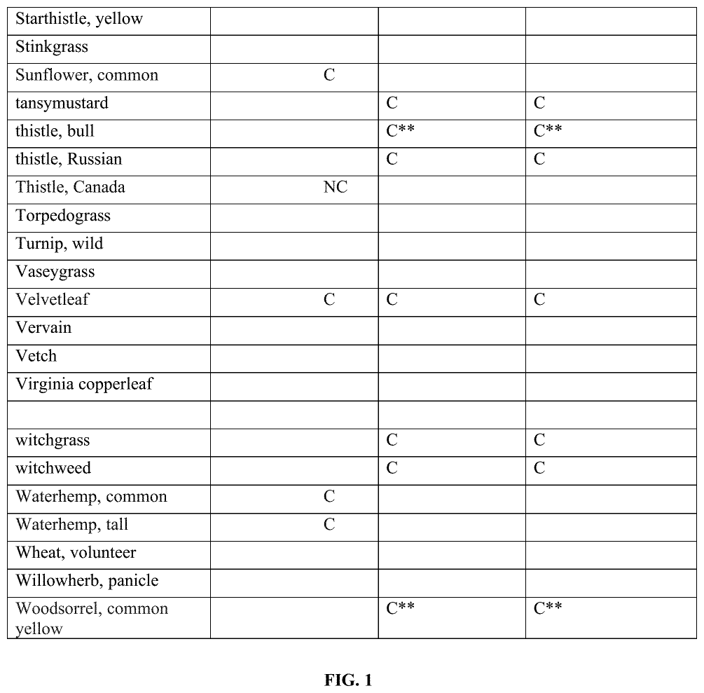

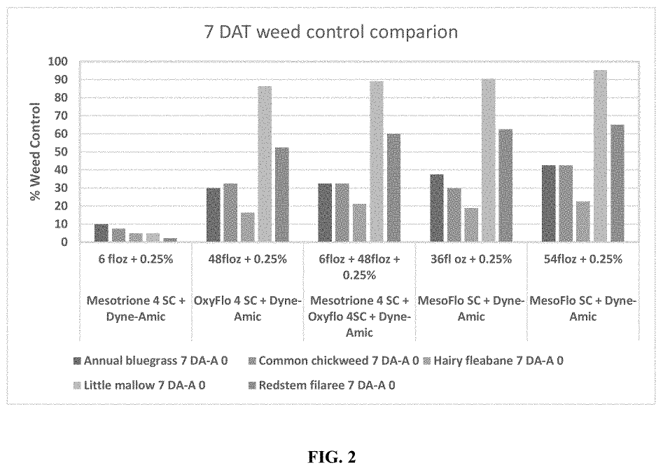

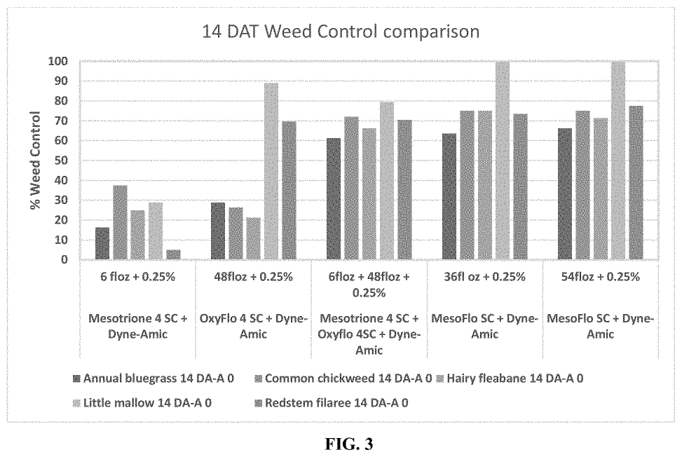

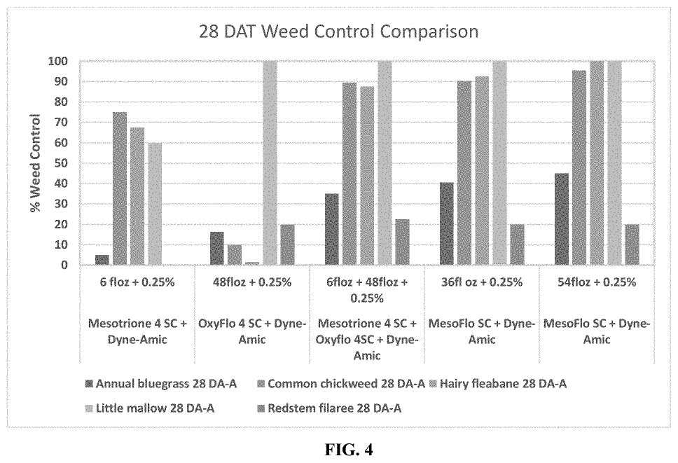

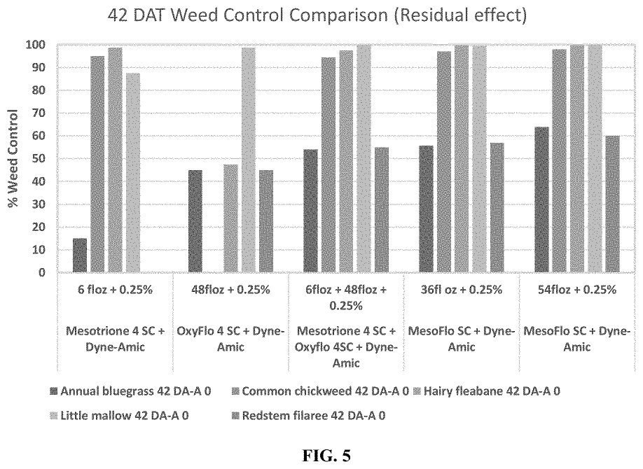

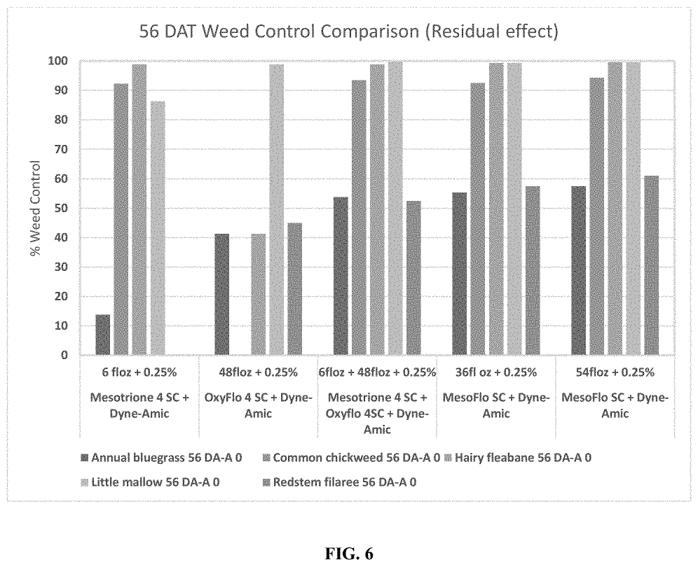

FIG. 1 is a table showing weed control provided by mesotrione relative to two exemplary oxyfluorfen compositions. This weed control chart demonstrates the compatible weed control effect provided by using mesotrione in combination with oxyfluorfen. That is, certain weeds that are controlled well by mesotrione are not controlled well by oxyfluorfen, whereas weeds controlled well by oxyfluorfen may not be well controlled by mesotrione. Accordingly, FIG. 1 provides support for using a combination comprising a triketone herbicide, such as mesotrione, and a diphenylether herbicide, such as oxyfluorfen, to provide a combination comprising two different herbicides particularly selected to have different, but compatible, biological modes of action and weed control activity.

### II. Triketone Herbicides

A. General Discussion

Certain triketone herbicides of the present invention have a Formula 1.

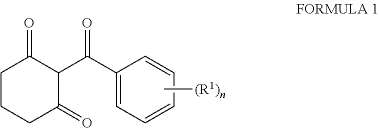

With reference to Formula 1, R¹ is selected from halogen (F, Cl, Br and I), nitro (NO₂), sulfonyl [—SO₂R² where R² is lower alkyl, such as C₁₋₆ alkyl (methyl, ethyl, propyl, butyl, pentyl, hexyl, and all stereo and geometric isomers thereof)], trihaloalkyl, such as trifluoromethyl (—CF₃), and trihaloalkoxy, such as trifluoroethoxymethyl (—CH₂OCH₂CF₃), and n=1, 2 or 3, typically 2 or 3. Ortho-substituted triketones are understood to be particularly active compounds. See, for example, Lee et al., The structure-activity relationships of the triketone class of HPPD herbicides, Pesticide Science, https://doi.org/10.1002/(SICI)1096-9063(199812)54:4<377::AID-PS827>3.0.CO; 2-0 (Mar. 26, 1999).

Certain triketone herbicides of the present invention have a following Formula 2 or Formula 3

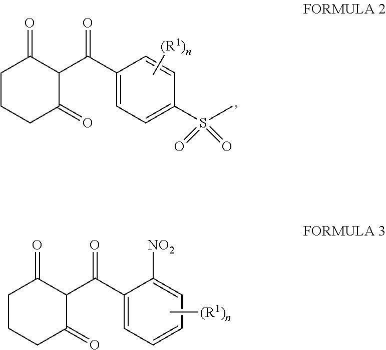

where the R¹ substituent is as stated above, and n=1 or 2. Exemplary triketone herbicides according to the present invention are provided below, along with their structural formulas, common names, and IUPAC names.

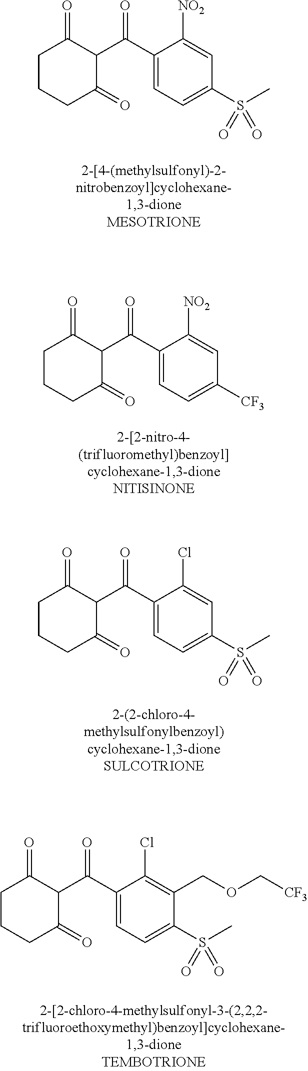 [SMILES: CS(=O)(=O)c1ccc(C(=O)C2C(=O)CCCC2=O)c([N+](=O)[O-])c1 ; O=C1CCCC(=O)C1C(=O)c1ccc(C(F)(F)F)cc1[N+](=O)[O-] ; CS(=O)(=O)c1ccc(C(=O)C2C(=O)CCCC2=O)c(Cl)c1 ; CS(=O)(=O)c1ccc(C(=O)C2C(=O)CCCC2=O)c(Cl)c1COCC(F)(F)F]

B. Mesotrione

Mesotrione is a preferred herbicide for use in combinations according to the present invention. Mesotrione is a 4-hydroxyphenylpyruvate dioxygenase (HPPD) inhibitor that functions as a selective herbicide, and is particularly suitable for controlling undesired vegetation in a maize locus. Mesotrione, a member of the triketone-class of herbicides, and more particularly benzoylcyclohexane-1,3-dione herbicides. Mesotrione often is formulated as a suspension concentrate, and has a water solubility of 1,500 mg/L at 20° C.

Mesotrione effectively controls a wide range of commercially-important weed species both pre- and post-emergence. Mesotrione controls a wide range of broad-leaved weeds, again particularly those that compete with maize, and can also suppress certain annual grass weeds that may be present in a crop. Mesotrione's selectivity is understood to be based on its greater potency on a target enzyme in dicotyledons relative to monocotyledons. Moreover, maize can metabolize the dione-containing ring.

Mesotrione exhibits a broad spectrum of activity on commercially important broadleaf weeds including, by way of example and without limitation, Abutilon theophrasti, Amaranthus powellii, Amaranthus retroflexus, Chenopodium album, Datura stramonium, Digitaria sanguinalis, Lamium purpureum, Polygonum persicaria, Rumex crispus, Senecio vulgaris, Solanum nigrum, Stellaria media and Xanthium strumarium.

Mesotrione can be applied to soil, and therefore is effective on emerging weeds. Additional weeds, by way of example and without limitation, that can be controlled post emergence using triketone herbicides, such as mesotrione, include palmer Amaranth, powell Amaranth, spiny Amaranth, Atriplex, Broadleaf signalgrass, wild Buckwheat, Buffalobur, Burcucumber, Carpetweed, wild Carrot, common Chickweed, common Cocklebur, large Crabgrass, curly Dock, Galinsoga, Hemp, Horsenettle, Jimsonweed, Horseweed (marestail), prostrate Knotweed, Kochia, common Lambsquarters, entireleaf Morningglory, ivyleaf Morningglory, pitted Morningglory, wild Mustard, black Nightshade, Eastern black Nightshade, hairy Nutsedge, yellow Nutsedge, redroot Pigweed, smooth Pigweed, tumble Pigweed, common Pokeweed, volunteer Potatoes, Florida Pusley, common Ragweed, giant Ragweed, hemp Sesbania, ladysthumb Smartweed, pale Smartweed, Pennsylvania Smartweed, common Sunflower, Velvetleaf, common Waterhemp, and tall Waterhemp.

### III. Diphenylether Herbicides

A. General Discussion

Certain diphenylether herbicides of the present invention have a following Formula 4.

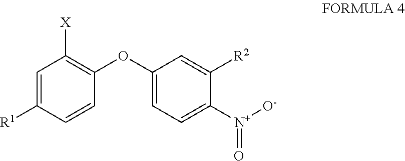

With reference to Formula 4, R¹ is lower alkyl or lower haloalkyl, such as C₁₋₆ alkyl or C₁₋₆ haloalkyl, particularly trifluoromethyl (—CF₃); X is F, Cl, Br or I, preferably Cl; R₂ is —CO₂H, or salts thereof, such metal or ammonium salts, CO₂R₃, where R³ is C₁₋₆ alkyl or

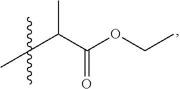 [SMILES: *C(C)C(=O)OCC]

ether, such as —O-lower alkyl, including C₁₋₆ alkyl, with one particular embodiment being an ethyl ether, —OCH₂CH₃, or R₂ is amidosulfonyl, such as

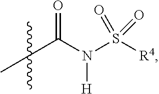

where R⁴ is C₁₋₆ alkyl, such as methyl.

Exemplary diphenylether herbicides according to the present invention are provided below, along with their structural formulas, common names, and IUPAC names.

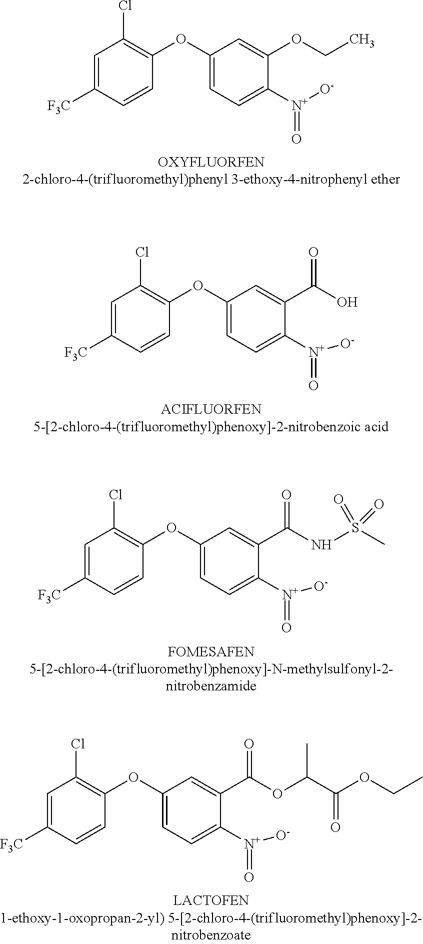 [SMILES: CCOc1cc(Oc2ccc(C(F)(F)F)cc2Cl)ccc1[N+](=O)[O-] ; O=C(O)c1cc(Oc2ccc(C(F)(F)F)cc2Cl)ccc1[N+](=O)[O-] ; CS(=O)(=O)NC(=O)c1cc(Oc2ccc(C(F)(F)F)cc2Cl)ccc1[N+](=O)[O-] ; CCOC(=O)C(C)OC(=O)c1cc(Oc2ccc(C(F)(F)F)cc2Cl)ccc1[N+](=O)[O-]]

B. Oxyfluorfen

Oxyfluorfen is a particular example of a diphenylether herbicide useful for forming combinations and compositions according to the present invention. Oxyfluorfen typically is used as an emulsifiable concentrate or granular formulation, and has a solubility of only 0.1 mg/L in water, but is highly soluble in most organic solvents.

Oxyfluorfen is a selective pre- and post-emergent herbicide that is often used to control certain annual broadleaf and grassy weeds in vegetables, fruit, cotton, ornamentals, and on non-crop areas (e.g. rail- and highway right-of-ways). Oxyfluorfen is classified as a protoporphyrinogen (PPO) inhibitor, and is a contact herbicide and light may be required for it to affect target plants.

Weeds, by way of example and without limitation, that can be controlled post emergence using diphenylether herbicides, such as oxyfluorfen, include Ageratum, spiny Amaranth, Balsamapple, Barnyardgrass (watergrass), catchweed bedstraw, catchweed, lesser bittercress, annual Bluegrass, wild Buckwheat, burclover, smallflower buttercup, buttonweed, broadleaf signalgrass, Burcucumber, Canarygrass, common Cocklebur, red clover, white clover, large Crabgrass, tropic Croton, cutleaf eveningprimrose, coast fiddleneck, broadleaf filaree, redstem filaree, whitestem filaree, fireweed, flixweed, giant foxtail, green foxtail, yellow foxtail, Carolina geranium, goosegrass, cutleaf groundcherry, Wright groundcherry, common groundsel, henbit Jimsonweed, Johnsongrass, seedling Florseweed (marestail), prostrate Knotweed, common Lambsquarters, prickly China lettuce, Mallow, Venice Mallow, little (Malva) Mayweed (dog fennel) minerslettuce, annual Morningglory, ivy leaf Morningglory, tall Morningglory, wild Mustard, black mustard, blue (purple) mustard, common yellow mustard, hedge mustard, tumble (Jim hill) mustard, wild mustard, burning nettle, black Nightshade, Eastern black Nightshade, hairy Nutsedge, yellow Nutsedge, wilds oats, red orach, oxalis (bermuda buttercup), redroot Pigweed, Florida Pusley, fall Panicum, Virginia pepperwood, yellowflower pepperwood, prostrate pigweed, scarlet pimpernel, wild poinsettia, puncturevine, common Pursley FL purslane, London rocket, Italian ryegrass, common Ragweed, field Sandbur, hemp Sesbania, prickly Sida (teaweed), broadleaf Signalgrass, ladysthumb Smartweed, Pennsylvania Shattercane, Shepherdspurse, red sorrel, annual sowthistle, birdseye speedwell, garden spurge, prostrate spurge, spotted spurge, corn spurry, tansymustard, bull thistle, Russian thistle, Velvetleaf, witchgrass, witchweed, and common yellow Woodsorrel.

### IV. Amounts of Active Technical Components

Combinations and compositions according to the present invention comprise appropriate effective amounts of a triketone herbicide and a diphenylether herbicide, such as compositions comprising mesotrione, or analogs thereof, and further comprising appropriate effective amounts of oxyfluorfen, or analogs thereof.

Disclosed combinations can be described by reference to relative amounts of each of the active technical components. The diphenylether herbicide may be used in excess relative to the triketone herbicide. For example, suitable relative amounts can range from about 5 to about 10 parts of the diphenylether herbicide, such as oxyfluorfen, relative to the triketone herbicide, such as mesotrione, and more typically range from about 7 to about 9 parts of the diphenylether herbicide relative to the triketone herbicide. One particular exemplary embodiment had a relative amount of 8.3:1 oxyfluorfen to mesotrione.

Compositions according to the present invention also can be described with reference to the weight percent of the two herbicides used to form a composition formulation, such as a premix concentrate that comprises, for example, mesotrione, or analogs thereof, and oxyfluorfen, or analogs thereof, relative to the weight of the total composition. For example, certain disclosed embodiments comprised, as weight percents relative to the weight of the entire formulation, from 30% to 50% diphenylether herbicide (using a 95.2% technical), more typically 30% to 40%, and even more typically 35%-40%, diphenylether herbicide. One particular embodiment comprised 38%-39% oxyfluorfen relative to the weight sum of all components comprising the composition. With reference to the triketone herbicide, certain disclosed embodiments had 1% up to 10% triketone herbicide (using a 98.3% technical), and more typically 2%-5% triketone herbicide. One particular embodiment included 4%-5% mesotrione relative to the weight sum of all components comprising the composition.

Disclosed embodiments can also be described with reference to the application rate per acre treated using a combination comprising a triketone herbicide and a diphenylether herbicide. Certain disclosed embodiments use application rates of: 45-50 fluid ounces of the diphenylether herbicide per acre, with a specific embodiment using 48 fluid ounces of the diphenylether herbicide, such as oxyfluorfen, per acre treated; and 4-10 fluid ounces of the triketone herbicide per acre treated, more typically 4 fluid ounces to 6 fluid ounces the triketone herbicide, such as mesotrione, per acre treated.

However, a person of ordinary skill in the art will appreciate that effective herbicidal compositions according to the present invention can comprise any number of actual amounts of a triketone herbicide and a diphenylether herbicide, such as mesotrione, or analogs thereof, and oxyfluorfen, or analogs thereof, and any relative amounts thereof, that are best suited for particular applications.

Compositions according to the present disclosure may be formulated for retail sale, such as a concentrated premix, that can be diluted by the end user to provide a substantially diluted formulation for application or can be part of a tank mix that is mixed by a user just prior to application. For example, initial compositions can be diluted by forming either an aqueous and/or an organic (e.g. using an alcohol, glycol or ether diluent and/or solvent) diluted product, using a dilution factor as may be required or desired for particular applications, including a dilution factor of from 1 to at least 1,000, such as from 100 to 350, and perhaps more typically 150 to 320 by weight. The dilution rate may also depend on how the initial composition is used or applied. With reference to certain exemplary embodiments: for a ground application, the product may be mixed in 20 gallons of water to spray over an acre; for aerial application, the product may be mixed in a lesser amount, such as 3 gallons of water for an acre spray; and the composition may be applied at higher dilution rates by chemigation through an irrigation system.

### V. Compositions/Combinations Comprising Diphenylether Herbicides and Triketone Herbicides

A. Miscellaneous Components

A person of ordinary skill in the art will appreciate that disclosed combinations and compositions can be used as aqueous formulations, organic formulations, emulsions, solid compositions, and the like, and may further comprise using additional components to meet various different application and/or formulation requirements. For example, disclosed compositions may include one or more additives to improve the biological performance of the composition, such as, for example, by improving wetting; retention or distribution on plant surfaces; or to improve uptake or mobility of the active compounds.

Additional exemplary components that can be used to make formulations according to the present invention include, by way of example and without limitation:

anionic surface active agents, fatty acid metal salts, salts of sulphuric acid aliphatic monoesters (e.g. sodium lauryl sulphate), salts of sulphonated aromatic compounds (e.g. sodium and calcium salts of dodecylbenzenesulphonate, butylnaphthalene sulphonate and sodium di-isopropyl- and tri-isopropyl-naphthalene sulphonates), phosphate esters (reaction products of fatty alcohols and phosphoric acid) (predominately mono-esters) or phosphorus pentoxide (predominately di-esters), for example the reaction between lauryl alcohol and tetraphosphoric acid; ether sulphates, alcohol ether sulphates (for example sodium laureth-3-sulphate), ether carboxylates (for example sodium laureth-3-carboxylate) in an amount of from greater than 0% by weight to at least 5% by weight;

anti-foaming/defoaming agents, such as silicone antifoam emulsions, for example polydimethylsiloxanes, with one particular antifoaming agent comprising SAG 1572, which is added at an effective amount of from greater than 0% to at least 1% of the total composition, such as 0.1% to 0.5%, with one particular embodiment using 0.2% SAG;

anti-freezing agents, such as alkyl glycols, including glycerol and propylene glycol, in an amount of from greater than 0% by weight to at least 15% by weight, with one particular embodiment comprising 12% glycerol;

cationic surface-active agents, such as quaternary ammonium compounds including, for example cetyltrimethyl ammonium bromide, imidazolines and amine salts in an amount of from greater than 0% by weight to at least 5% by weight;

dispersing agents, such as ethoxylated aryl compounds, including tristyrylphenol as an example, in an amount of greater than 0% up to at least 5%, and typically about 4%;

fillers, such as silica, including precipitated silica, in an amount of from greater than 0% to at least 2%;

fertilizers, such as ammonium sulfate, ammonium phosphate, ammonium nitrate, ureas; vegetable products, such as cereal meal, tree bark meal, wood meal, nutshell meal, and mixtures thereof in an amount as recommended for the particular fertilizer;

liquid carriers, including water, toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methanol, ethanol, isopropanol, amyl alcohol, ethylene glycol, propylene glycol, glycerine, N-methyl-2-pyrrolidinone, N,N-dimethyl alkylamides, dimethyl sulfoxide, liquid fertilizers. Water is generally used to form concentrates in an amount of from greater than 0% by weight to at least 50% by weight, with one particular embodiment according to the present invention comprising 41% to 42% water;

non-ionic surface active agents: including alkylene oxide condensation products, such as ethylene, propylene or butylene oxide; fatty alcohols (such as oleyl alcohol or cetyl alcohol); alkylphenols (such as octyl or nonylphenol); long chain fatty acid esters or hexitol anhydrides; condensation products of esters with ethylene oxide; block polymers (such as block polymers comprising ethylene oxide and propylene oxide); alkanolamides; and lecithins; in an amount of from greater than 0% by weight to at least 5% by weight;

microbiocides, such as to control bacteria and fungi in containers, with suitable exemplary microbiocides comprising isothiazolinones, such as Acticide LA 1206, which comprises 2-bromo-2-nitropropane-1,3 diol, 4-chloro-2-methyl-4-isothazolin-3-one and 2-methyl-4-isothiazoline-3-one as active ingredients, and Proxel GXL, which comprises (a 20% aqueous dipropylene glycol solution of 1,2-benzisothiazolin-3-one). Microbicides are used in disclosed composition embodiments at an inclusion percentage of from greater than 0% to at least 1% of the total composition by weight, typically 0.1% to 0.2%;

pH adjustors, which are added at amounts required to obtain desired formulation pHs, and include both inorganic and organic acids and bases, such as mineral acids and bases, including sodium hydroxide, potassium hydroxide, ammonium hydroxide, hydrochloric acid and sulfuric acid;

rheology aids, such as xanthan gum, in an amount of from greater than 0% to at least 1% of the total composition, typically from 0.1% to about 0.3%, with one particular embodiment of the present invention using 0.1% Kelzan S Plus, xanthan gum, rheology aid;

safeners, which provide better crop plant compatibility when applied jointly with active herbicides. Some safeners are themselves herbicidally active, and may act as an antidote to or antagonist in the crop plants and thus reduce or even prevent damage to the crop plants. Suitable exemplary safeners include AD 67 (MON 4660), benoxacor, cloquintocet-mexyl (including lithium, sodium, potassium, calcium, magnesium, aluminium, iron, ammonium, quaternary ammonium, sulfonium or phosphonium salts thereof), cyometrinil, dicyclinon, dietholate, cyprosulfamide (CAS RN 221667-31-8), oxabetrinil, dichlormid, fenchlorazole-ethyl, fenclorim, fluxofenim, furilazole, flurazole, isoxadifen-ethyl, mefenpyr-diethyl, mephenate, naphthalic acid anhydride, N-isopropyl-4-(2-methoxy-benzoylsulfamoyl)-benzamide (CAS RN 221668-34-4), N-(2-methoxybenzoyl)-4-[(methylaminocarbonyl)amino]-benzenesulfonamide, 2,2,5-trimethyl-3-(dichloracetyl)-1,3-oxazolidine, 4-(dichloroacetyl)-1-oxa-4-azaspiro[4.5]decane and oxabetrinil, agriculturally acceptable salts and derivatives thereof, and 2,2,5-Trimethyl-3-(dichloroacetyl)-1,3-oxazolidine [CAS No. 52836-31-4] (also known as R-29148. 4-(Dichloroacetyl)-1-oxa-4-azaspiro[4.5]decane). Safeners can be used in any efficacious amount, such as an amount of the active or actives to the safener of from 100:1 to 1:10;

solid carriers, such as talc, pyrophyllite clay, silica, silicates, diatomaceous earth, attapulgite clay, kaolin clay, kieselguhr, chalk, diatomaceous earth, lime, calcium carbonate, bentonite clay, dolomite, Fuller's earth, cotton seed hulls, mineral earths, wheat flour, soybean flour, pumice, wood flour, walnut shell flour, lignin, calcium sulfate, magnesium sulfate, magnesium oxide; polysaccharides, e.g. cellulose, starch etc., in an amount of from greater than 0% by weight to at least 50% by weight;

solvents and co-solvents, such as water and/or organic solvents, including alcohols and glycols, particularly C₁₋₁₀ alcohols or glycols, such as isobutyl alcohol and hexylene glycol, and ethers, including ethoxylated compounds. Certain embodiments according to the present invention included greater than 0% up to at least 50% water, such as from about 25% to about 40% by weight water

spray additives based on oils, for example certain mineral oils or natural plant oils (such as soybean and rape seed oil), and blends of these with other bio-enhancing adjuvants (ingredients which may aid or modify the action of the active compounds) in an amount of from greater than 0% by weight to at least 5% by weight;

surfactants, such as sulphosuccinates, including sodium dioctylsulfphosuccinate, in an amount of greater than 0% up to at least 5%, and typically about 3%, with on particular embodiment of the present invention comprising 3% Agent SCB1 surfactant;

suspending agents, such as colloids (including polysaccharides, polyvinylpyrrolidone or sodium carboxymethylcellulose) and swelling clays (such as bentonite or attapulgite) in an amount of from greater than 0% by weight to at least 5% by weight;

wetting agents, dispersing agents and emulsifying agents may be cationic, anionic, amphoteric or non-ionic type in an amount of from greater than 0% by weight to at least 5% by weight; and

any and all other components useful for forming combinations in this field as will be understood by a person of ordinary skill in the art, including adjuvants, such as compatibilizing agents, sequestering agents, neutralizing agents, buffers, corrosion inhibitors, dyes, odorants, spreading agents, penetration aids, sticking agents, dispersing agents, thickening agents, etc.

Particular compositions according to the present invention included a diphenylether herbicide, a triketone herbicide, a surfactant, a freeze/thaw agent, a defoamer, a rheology aid, an antimicrobial agent and a carrier.

B. Other Active Pesticides and/or Herbicides

A person of ordinary skill in the art will appreciate that certain of the presently disclosed combinations or compositions comprising mesotrione and oxyfluorfen or analogs thereof, also can be combined with, or used in combination with, other active herbicides at any desired effective amount, such as greater than 0% by weight up to at least 50% by weight. When used in conjunction with other co-herbicides, disclosed embodiments of the present composition can be formulated with the other co-herbicide or co-herbicides, tank mixed with the other co-herbicide or co-herbicides, or applied simultaneously or sequentially in any order with the other co-herbicide or co-herbicides. Such co-herbicide or co-herbicides can include at least one additional herbicide or herbicide safener of any suitable class of herbicide. Classes of additional suitable inhibitors include a lipid biosynthesis inhibitor, an ALS inhibitor, a photosynthesis inhibitor, protoporphyrinogen-IX-oxidase inhibitor, a bleacher-herbicide based on inhibition of the carotenoid biosynthesis, an EPSP synthase inhibitor, a glutamine synthetase inhibitor, a DHP synthase inhibitor, a mitosis inhibitor, a VLCFA inhibitor, which is based on inhibiting synthesis of very long chain fatty acids, a cellulose biosynthesis inhibitor, a de-coupler herbicide, which is based on disrupting cell membranes, an auxinic herbicide, and an auxin transport inhibitor. More specifically, such additional inhibitors include, but are not limited to: acetolactate synthase inhibitors [ALS, which also may be referred to as acetohydroxy acid synthase (AHAS) inhibitors], such as triazolopyrimidine herbicides, sulfonylamino-carbonyl-triazolinone herbicides, pyrimidinyl(thio) benzoate herbicides, and imidizolinone herbicides; protoporphyrinogen oxidase inhibitors (PPO), such as pyrimidinedione herbicides, triazolinone herbicides, diphenyl ether herbicides, and N-phenyl phthalimide herbicides; synthetic auxins, such as benzoic acid herbicides, quinolinecarboxylic acid herbicides; pyridine carboxylic acid herbicides; phenoxycarboxylic acid herbicides; microtubule inhibitors, such as dinitroaniline herbicides, e.g. benfluralin, butralin, dinitramine, ethalfluralin, fluchloralin, oryzalin, pendimethalin, prodiamine and trifluralin; phosphoroamidate herbicides, such as amiprophos, amiprophos-methyl and butamiphos; pyridine herbicides, such as dithiopyr and thiazopyr; additional different benzamide herbicides, such as tebutam; and additional benzoic acid herbicides, such as chlorthal and chlorthal-dimethyl; acetyl-CoA carboxylase inhibitors, such as aryloxyphenoxy-propionate herbicides; cyclohexanedione herbicides; phenylpyrazoline herbicides; photosystem II inhibitors, such as arylurea herbicides, triazin(di)one herbicides, triazine herbicides, pyridazinone herbicides, phenylcarbamate herbicides, nitrile herbicides, benzothiadiazinone herbicides, and uracil herbicides; pigment synthesis inhibitors, such as arylurea herbicides, triazin(di)one herbicides, triazine herbicides, pyridazinone herbicides, phenylcarbamate herbicides, nitrile herbicides, benzothiadiazinone herbicides, and uracil herbicides; and VLCFA inhibitors, such as chloroacetamide herbicides, oxyacetamide herbicides, and tetrazolinone herbicides.

Particular examples of such co-herbicides include, by way of example, and without limitation, ioxynil, aclonifen, acrolein, azafenidin, azimsulfuron, asulam, acetochlor, atrazine, anilofos, amicarbazone, amidosulfuron, amitrole, aminocyclopyrachlor, aminopyralid, amiprofos-methyl, ametryn, alachlor, alloxydim, ancymidol, isouron, isoxachlortole, isoxaflutole, isoxaben, Isodecylalkoholethoxylat, isoproturon, ipfencarbazone, imazaquin, imazapic (including salts such as amine), imazapyr (including salts such as isopropylamine), imazamethabenz-methyl, imazamox, imazosulfuron, indaziflam, indanofan, eglinazine-ethyl, esprocarb, ethametsulfuron-methyl, ethalfluralin, ethidimuron, ethoxysulfuron, ethoxyfen-ethyl, ethofumesate, etobenzanid, endothal-disodium, oxadiazon, oxadiargyl, oxaziclomefone, oxasulfuron, oxyfluorfen, oryzalin, orthosulfamuron, orbencarb, oleic acid, cafenstrole, carfentrazone-ethyl, karbutilate, carbetamide, quizalofop, quizalofop-ethyl, quizalofop-P-ethyl, quizalofop-P-tefuryl, quinoclamine, quinclorac, quinmerac, cumyluron, clacyfos, glyphosate (including salts such as sodium, potassium, amine, propylamine, isopropylamine, dimethylamine or trimesium), glufosinate (including salts such as amine or sodium), glufosinate-P, glufosinate-P-sodium, clethodim, clodinafop-propargyl, clopyralid, clomazone, chlomethoxyfen, clomeprop, cloransulam-methyl, chloramben, chloridazon, chlorimuron-ethyl, chlorsulfuron, chlorthal-dimethyl, chlorthiamid, chlorphthalim, chlorflurenol-methyl, chlorpropham, chlorbromuron, chloroxuron, chlorotoluron, ketospiradox (including salts such as sodium, calcium, or ammonia), saflufenacil, sarmentine, cyanazine, cyanamide, diuron, diethatyl-ethyl, dicamba (including salts such as amine, diethylamine, isopropylamine, diglycolamine, sodium or lithium), cycloate, cycloxydim, diclosulam, cyclosulfamuron, cyclopyrimorate, dichlobenil, diclofop-P-methyl, diclofop-methyl, dichlorprop, dichlorprop-P, diquat, dithiopyr, siduron, dinitramine, cinidon-ethyl, cinosulfuron, dinoseb, dinoterb, cyhalofop-butyl, diphenamid, difenzoquat, diflufenican, diflufenzopyr, simazine, dimethachlor, dimethametryn, dimethenamid, dimethenamid-P, simetryn, dimepiperate, dimefuron, cinmethylin, swep, sulfentrazone, sulfosate, sulfosulfuron, sulfometuron-methyl, sethoxydim, terbacil, daimuron, thaxtomin A, dalapon, thiazopyr, tiafenacil, thiencarbazone (including sodium salt, methyl ester or the like), tiocarbazil, thiobencarb, thidiazimin, thidiazuron, thifensulfuron-methyl, desmedipham, desmetryne, thenylchlor, tebutam, tebuthiuron, tepraloxydim, tefuryltrione, terbuthylazine, terbutryn, terbumeton, topramezone, tralkoxydim, triaziflam, triasulfuron, triafamone, tri-allate, trietazine, triclopyr, triclopyr-butotyl, tritosulfuron, trifludimoxazin, triflusulfuron-methyl, trifluralin, trifloxysulfuron-sodium, tribenuron-methyl, tolpyralate, naptalam (including salts such as sodium), naproanilide, napropamide, napropamide-M, nicosulfuron, neburon, norflurazon, vernolate, paraquat dichloride, halauxifen-benzyl, halauxifen-methyl, haloxyfop, haloxyfop-P, haloxyfop-etotyl, halosafen, halosulfuron-methyl, picloram, picolinafen, bicyclopyrone, bispyribac-sodium, pinoxaden, bifenox, piperophos, pyraclonil, pyrasulfotole, pyrazoxyfen, pyrazosulfuron-ethyl, pyrazolynate, bilanafos, pyraflufen-ethyl, pyridafol, pyrithiobac-sodium, pyridate, pyriftalid, pyributicarb, pyribenzoxim, pyrimisulfan, pyriminobac-methyl, pyroxasulfone, pyroxsulam, phenisopham, fenuron, fenoxasulfone, fenoxaprop (including methyl, ethyl and isopropyl ester), fenoxaprop-P (including methyl, ethyl and isopropyl ester), fenthiaprop-ethyl, fentrazamide, phenmedipham, foramsulfuron, butachlor, butafenacil, butamifos, butylate, butenachlor, butralin, butroxydim, flazasulfuron, flamprop (including methyl, ethyl and isopropyl ester), flamprop-M (including methyl, ethyl and isopropyl ester), primisulfuron-methyl, fluazifop-butyl, fluazifop-P-butyl, fluazolate, fluometuron, fluoroglycofen-ethyl, flucarbazone-sodium, fluchloralin, flucetosulfuron, fluthiacet-methyl, flupyrsulfuron-methyl (including salts such as sodium, calcium or ammonia), flufenacet, flufenpyr-ethyl, flupropanate, flupoxame, flumioxazin, flumiclorac-pentyl, flumetsulam, fluridone, flurtamone, fluroxypyr (including esters such as butomethyl and meptyl, and salts such as sodium, calcium or ammonia), flurochloridone, pretilachlor, procarbazone-sodium, prodiamine, prosulfuron, prosulfocarb, propaquizafop, propachlor, propazine, propanil, propisochlor, propyrisulfuron, propham, profluazol, prohexadione-calcium, propoxycarbazone, propoxycarbazone-sodium, profoxydim, bromacil, brompyrazon, prometryn, prometon, bromoxynil (including esters such as butyric acid, octanoic acid or heptanoic acid), bromofenoxim, bromobutide, florasulam, florpyrauxifen, florpyrauxifen-benzyl, hexazinone, pethoxamid, benazolin, penoxsulam, heptamaloxyloglucan, beflubutamid, pebulate, pelargonic acid, bencarbazone, pendimethalin, benzfendizone, bensulide, bensulfuron-methyl, benzobicyclon, benzofenap, bentazone, pentanochlor, pentoxazone, benfluralin, benfuresate, fosamine, foramsulfuron, forchlorfenuron, mecoprop (including salts such as sodium, potassium, isopropylamine, triethanolamine or dimethylamine), mecoprop-P-potassium, mesosulfuron (including esters such as methyl), metazachlor, metazosulfuron, methabenzthiazuron, metamitron, metamifop, metam, DSMA, methiozolin, methyldymuron, metoxuron, metosulam, metsulfuron-methyl, metobromuron, metobenzuron, metolachlor, metribuzin, mepiquat chloride, mefenacet, monosulfuron (including methyl, ethyl and isopropyl ester), monolinuron, molinate, iodosulfuron, iodosulfulon-methyl-sodium, iofensulfuron, iofensulfuron-sodium, lancotrione, linuron, rimsulfuron, lenacil, TCA (including salts such as sodium, calcium or ammonia), 2,3,6-TBA, 2,4,5-T, 2,4-D (including salts such as amine, diethylamine, triethanolamine, isopropylamine, sodium or lithium), ACN, AE-F-150944 (Code number), MCPA, MCPB (including sodium salt, ethyl ester or the like), 2,4-DB, DNOC (including salts such as amine or sodium), MCPA-thioethyl, IR-6396 (Code number), SYP-298 (Code number), SYP-300 (Code number), EPTC, S-metolachlor, S-9750 (Code number), MSMA, and HW-02 (Code number), as well as salts and analogues of these compounds; 2,3,6-TBA, 2,3,6-TBA-dimethylammonium, 2,3,6-TBA-sodium, 2,4,5-T, 2,4,5-T-2-butoxypropyl, 2,4,5-T-2-ethylhexyl, 2,4,5-T-3-butoxypropyl, 2,4,5-TB, 2,4,5-T-butometyl, 2,4,5-T-butotyl, 2,4,5-T-butyl, 2,4,5-T-isobutyl, 2,4,5-T-isoctyl, 2,4,5-T-isopropyl, 2,4,5-T-methyl, 2,4,5-T-pentyl, 2,4,5-T-sodium, 2,4,5-T-triethylammonium, 2,4,5-T-trolamine, 2,4-D, 2,4-D-2-butoxypropyl, 2,4-D-2-ethylhexyl, 2,4-D-3-butoxypropyl, 2,4-D-ammonium, 2,4-DB, 2,4-DB-butyl, 2,4-DB-dimethylammonium, 2,4-DB-isoctyl, 2,4-DB-potassium, 2,4-DB-sodium, 2,4-D-butotyl, 2,4-D-butyl, 2,4-D-diethylammonium, 2,4-D-dimethylammonium, 2,4-D-diolamine, 2,4-D-dodecylammonium, 2,4-DEB, 2,4-DEP, 2,4-D-ethyl, 2,4-D-heptylammonium, 2,4-D-isobutyl, 2,4-D-isoctyl, 2,4-D-isopropyl, 2,4-D-isopropylammonium, 2,4-D-lithium, 2,4-D-meptyl, 2,4-D-methyl, 2,4-D-octyl, 2,4-D-pentyl, 2,4-D-potassium, 2,4-D-propyl, 2,4-D-sodium, 2,4-D-tefuryl, 2,4-D-tetradecylammonium, 2,4-D-triethylammonium, 2,4-D-tris(2-hydroxypropyl)ammonium, 2,4-D-trolamine, 3,4-DA, 3,4-DB, 3,4-DP, 4-CPA, 4-CPB, 4-CPP, acetochlor, aclonifen, acrolein, alachlor, allidochlor, alloxydim, alloxydim-sodium, allyl alcohol, alorac, ametridione, ametryn, amibuzin, amicarbazone, amidosulfuron, aminocyclopyrachlor, aminocyclopyrachlor-methyl, aminocyclopyrachlor-potassium, aminopyralid, aminopyralid-potassium, aminopyralid-tris(2-hydroxypropyl)ammonium, amiprofos-methyl, amitrole, ammonium sulfamate, anilofos, anisuron, asulam, asulam-potassium, asulam-sodium, atraton, atrazine, azafenidin, azimsulfuron, aziprotryne, barban, BCPC, beflubutamid, benazolin, benazolin-dimethylammonium, benazolin-ethyl, benazolin-potassium, bencarbazone, benfluralin, benfuresate, bensulfuron, bensulfuron-methyl, bensulide, bentazone, bentazone-sodium, benzadox, benzadox-ammonium, benzfendizone, benzipram, benzobicyclon, benzofenap, benzofluor, benzoylprop, benzoylprop-ethyl, benzthiazuron, bicyclopyrone, bifenox, bilanafos, bilanafos-sodium, bispyribac, bispyribac-sodium, borax, bromacil, bromacil-lithium, bromacil-sodium, bromobonil, bromobutide, bromofenoxim, bromoxynil, bromoxynil butyrate, bromoxynil heptanoate, bromoxynil octanoate, bromoxynil-potassium, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole, carfentrazone, carfentrazone-ethyl, CDEA, CEPC, chlomethoxyfen, chloramben, chloramben-ammonium, chloramben-diolamine, chloramben-methyl, chloramben-methylammonium, chloramben-sodium, chloranocryl, chlorazifop, chlorazifop-propargyl, chlorazine, chlorbromuron, chlorbufam, chloreturon, chlorfenac, chlorfenac-sodium, chlorfenprop, chlorfenprop-methyl, chlorflurazole, chlorflurenol, chlorflurenol-methyl, chloridazon, chlorimuron, chlorimuron-ethyl, chlornitrofen, chloropon, chlorotoluron, chloroxuron, chloroxynil, chlorprocarb, chlorpropham, chlorsulfuron, chlorthal, chlorthal-dimethyl, chlorthal-monomethyl, chlorthiamid, cinidon-ethyl, cinmethylin, cinosulfuron, cisanilide, clethodim, cliodinate, clodinafop, clodinafop-propargyl, clofop, clofop-isobutyl, clomazone, clomeprop, cloprop, cloproxydim, clopyralid, clopyralid-methyl, clopyralid-olamine, clopyralid-potassium, clopyralid-tris(2-hydroxypropyl)ammonium, cloransulam, cloransulam-methyl, CMA, copper sulfate, CPMF, CPPC, credazine, cresol, cumyluron, cyanamide, cyanatryn, cyanazine, cycloate, cyclosulfamuron, cycloxydim, cycluron, cyhalofop, cyhalofop-butyl, cyperquat, cyperquat chloride, cyprazine, cyprazole, cypromid, daimuron, dalapon, dalapon-calcium, dalapon-magnesium, dalapon-sodium, dazomet, dazomet-sodium, delachlor, desmedipham, desmetryn, di-allate, dicamba, dicamba-dimethylammonium, dicamba-diolamine, dicamba-isopropylammonium, dicamba-methyl, dicamba-olamine, dicamba-potassium, dicamba-sodium, dicamba-trolamine, dichlobenil, dichloralurea, dichlormate, dichlorprop, dichlorprop-2-ethylhexyl, dichlorprop-butotyl, dichlorprop-dimethylammonium, dichlorprop-ethylammonium, dichlorprop-isoctyl, dichlorprop-methyl, dichlorprop-P, dichlorprop-P-dimethylammonium, dichlorprop-potassium, dichlorprop-sodium, diclofop, diclofop-methyl, diclosulam, diethamquat, diethamquat dichloride, diethatyl, diethatyl-ethyl, difenopenten, difenopenten-ethyl, difenoxuron, difenzoquat, difenzoquat metilsulfate, diflufenican, diflufenzopyr, diflufenzopyr-sodium, dimefuron, dimepiperate, dimethachlor, dimethametryn, dimethenamid, dimethenamid-P, dimexano, dimidazon, dinitramine, dinofenate, dinoprop, dinosam, dinoseb, dinoseb acetate, dinoseb-ammonium, dinoseb-diolamine, dinoseb-sodium, dinoseb-trolamine, dinoterb, dinoterb acetate, diphacinone-sodium, diphenamid, dipropetryn, diquat, diquat dibromide, disul, disul-sodium, dithiopyr, diuron, DMPA, DNOC, DNOC-ammonium, DNOC-potassium, DNOC-sodium, DSMA, EBEP, eglinazine, eglinazine-ethyl, endothal, endothal-diammonium, endothal-dipotassium, endothal-disodium, epronaz, EPTC, erbon, esprocarb, ethalfluralin, ethametsulfuron, ethametsulfuron-methyl, ethidimuron, ethiolate, ethofumesate, ethoxyfen, ethoxyfen-ethyl, ethoxysulfuron, etinofen, etnipromid, etobenzanid, EXD, fenasulam, fenoprop, fenoprop-3-butoxypropyl, fenoprop-butometyl, fenoprop-butotyl, fenoprop-butyl, fenoprop-isoctyl, fenoprop-methyl, fenoprop-potassium, fenoxaprop, fenoxaprop-ethyl, fenoxaprop-P, fenoxaprop-P-ethyl, fenoxasulfone, fenteracol, fenthiaprop, fenthiaprop-ethyl, fentrazamide, fenuron, fenuron TCA, ferrous sulfate, flamprop, flamprop-isopropyl, flamprop-M, flamprop-methyl, flamprop-M-isopropyl, flamprop-M-methyl, flazasulfuron, florasulam, fluazifop, fluazifop-butyl, fluazifop-methyl, fluazifop-P, fluazifop-P-butyl, fluazolate, flucarbazone, flucarbazone-sodium, flucetosulfuron, fluchloralin, flufenacet, flufenican, flufenpyr, flufenpyr-ethyl, flumetsulam, flumezin, flumiclorac, flumiclorac-pentyl, flumioxazin, flumipropyn, fluometuron, fluorodifen, fluoroglycofen, fluoroglycofen-ethyl, fluoromidine, fluoronitrofen, fluothiuron, flupoxam, flupropacil, flupropanate, flupropanate-sodium, flupyrsulfuron, flupyrsulfuron-methyl-sodium, fluridone, flurochloridone, fluroxypyr, fluroxypyr-butometyl, fluroxypyr-meptyl, flurtamone, fluthiacet, fluthiacet-methyl, foramsulfuron, fosamine, fosamine-ammonium, furyloxyfen, glufosinate, glufosinate-ammonium, glufosinate-P, glufosinate-P-ammonium, glufosinate-P-sodium, glyphosate, glyphosate-diammonium, glyphosate-dimethylammonium, glyphosate-isopropylammonium, glyphosate-monoammonium, glyphosate-potassium, glyphosate-sesquisodium, glyphosate-trimesium, halosafen, halosulfuron, halosulfuron-methyl, haloxydine, haloxyfop, haloxyfop-etotyl, haloxyfop-methyl, haloxyfop-P, haloxyfop-P-etotyl, haloxyfop-P-methyl, haloxyfop-sodium, hexachloroacetone, hexaflurate, hexazinone, imazamethabenz, imazamethabenz-methyl, imazamox, imazamox-ammonium, imazapic, imazapic-ammonium, imazapyr, imazapyr-isopropylammonium, imazaquin, imazaquin-ammonium, imazaquin-methyl, imazaquin-sodium, imazethapyr, imazethapyr-ammonium, imazosulfuron, indanofan, indaziflam, iodobonil, iodomethane, iodosulfuron, iodosulfuron-methyl-sodium, ioxynil, ioxynil octanoate, ioxynil-lithium, ioxynil-sodium, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lenacil, linuron, MAA, MAMA, MCPA, MCPA-2-ethylhexyl, MCPA-butotyl, MCPA-butyl, MCPA-dimethylammonium, MCPA-diolamine, MCPA-ethyl, MCPA-isobutyl, MCPA-isoctyl, MCPA-isopropyl, MCPA-methyl, MCPA-olamine, MCPA-potassium, MCPA-sodium, MCPA-thioethyl, MCPA-trolamine, MCPB, MCPB-ethyl, MCPB-methyl, MCPB-sodium, mecoprop, mecoprop-2-ethylhexyl, mecoprop-dimethylammonium, mecoprop-diolamine, mecoprop-ethadyl, mecoprop-isoctyl, mecoprop-methyl, mecoprop-P, mecoprop-P-dimethylammonium, mecoprop-P-isobutyl, mecoprop-potassium, mecoprop-P-potassium, mecoprop-sodium, mecoprop-trolamine, medinoterb, medinoterb acetate, mefenacet, mefluidide, mefluidide-diolamine, mefluidide-potassium, mesoprazine, mesosulfuron, mesosulfuron-methyl, metam, metam-ammonium, metamifop, metamitron, metam-potassium, metam-sodium, metazachlor, metazosulfuron, metflurazon, methabenzthiazuron, methalpropalin, methazole, methiobencarb, methiozolin, methiuron, methometon, methoprotryne, methyl bromide, methyl isothiocyanate, methyldymron, metobenzuron, metolachlor, metosulam, metoxuron, metribuzin, metsulfuron, metsulfuron-methyl, molinate, monalide, monisouron, monochloroacetic acid, monolinuron, monuron, monuron TCA, morfamquat, morfamquat dichloride, MSMA, naproanilide, napropamide, naptalam, naptalam-sodium, neburon, nicosulfuron, nipyraclofen, nitralin, nitrofen, nitrofluorfen, norflurazon, noruron, OCH, orbencarb, ortho-dichlorobenzene, orthosulfamuron, oryzalin, oxadiargyl, oxadiazon, oxapyrazon, oxapyrazon-dimolamine, oxapyrazon-sodium, oxasulfuron, oxaziclomefone, parafluron, paraquat, paraquat dichloride, paraquat dimetilsulfate, pebulate, pelargonic acid, pendimethalin, penoxsulam, pentachlorophenol, pentanochlor, pentoxazone, perfluidone, pethoxamid, phenisopham, phenmedipham, phenmedipham-ethyl, phenobenzuron, phenylmercury acetate, picloram, picloram-2-ethylhexyl, picloram-isoctyl, picloram-methyl, picloram-olamine, picloram-potassium, picloram-triethylammonium, picloram-tris(2-hydroxypropyl)ammonium, picolinafen, pinoxaden, piperophos, potassium arsenite, potassium azide, potassium cyanate, pretilachlor, primisulfuron, primisulfuron-methyl, procyazine, prodiamine, profluazol, profluralin, profoxydim, proglinazine, proglinazine-ethyl, prometon, prometryn, propachlor, propanil, propaquizafop, propazine, propham, propisochlor, propoxycarbazone, propoxycarbazone-sodium, propyrisulfuron, prosulfalin, prosulfocarb, prosulfuron, proxan, proxan-sodium, prynachlor, pydanon, pyraclonil, pyraflufen, pyraflufen-ethyl, pyrasulfotole, pyrazolynate, pyrazosulfuron, pyrazosulfuron-ethyl, pyrazoxyfen, pyribenzoxim, pyributicarb, pyriclor, pyridafol, pyridate, pyriftalid, pyriminobac, pyriminobac-methyl, pyrimisulfan, pyrithiobac, pyrithiobac-sodium, pyroxasulfone, pyroxsulam, quinclorac, quinmerac, quinoclamine, quinonamid, quizalofop, quizalofop-ethyl, quizalofop-P, quizalofop-P-ethyl, quizalofop-P-tefuryl, rhodethanil, rimsulfuron, saflufenacil, sebuthylazine, secbumeton, sethoxydim, siduron, simazine, simeton, simetryn, SMA, S-metolachlor, sodium arsenite, sodium azide, sodium chlorate, sulfallate, sulfentrazone, sulfometuron, sulfometuron-methyl, sulfosulfuron, sulfuric acid, sulglycapin, swep, TCA, TCA-ammonium, TCA-calcium, TCA-ethadyl, TCA-magnesium, TCA-sodium, tebutam, tebuthiuron, tefuryltrione, tepraloxydim, terbacil, terbucarb, terbuchlor, terbumeton, terbuthylazine, terbutryn, tetrafluron, thenylchlor, thiazafluron, thiazopyr, thidiazimin, thidiazuron, thiencarbazone, thiencarbazone-methyl, thifensulfuron, thifensulfuron-methyl, thiobencarb, tiocarbazil, tioclorim, topramezone, tralkoxydim, tri-allate, triasulfuron, triaziflam, tribenuron, tribenuron-methyl, tricamba, triclopyr, triclopyr-butotyl, triclopyr-ethyl, triclopyr-triethylammonium, tridiphane, trietazine, trifloxysulfuron, trifloxysulfuron-sodium, trifluralin, triflusulfuron, triflusulfuron-methyl, trifop, trifop-methyl, trifopsime, trihydroxytriazine, trimeturon, tripropindan, tritac, tritosulfuron, vernolate, or xylachlor; and wherein the herbicide safener is selected from benoxacor, cloquintocet-mexyl, cyprosulfamide, dichlormid, fenchlorazole-ethyl, fenclorim, fluxofenim, furilazole and the corresponding R isomer, isoxadifen-ethyl, mefenpyr-diethyl, oxabetrinil, N-isopropyl-4-(2-methoxy-benzoylsulfamoyl)-benzamide, and N-(2-methoxybenzoyl)-4-[methylaminocarbonyl)amino]benzenesulfonamide.

Certain disclosed embodiments concern using a combination of, or a composition comprising, a triketone herbicide and a diphenylether acid herbicide with one or more co-herbicides selected from: 2,4-D, acetochlor, metolachlor, metolachlor S, azoxystrobin, azoxystrobin plus metalaxyl, azoxystrobin plus propiconazole, bromoxynil, carfentrazone, clopyralid, flucarbazone, flumetsulam, fluroxypyr, fluroxypyr plus clopyralid, imazamox, imazethapyr, imazamox plus imazethapyr, imidacloprid, cyhalothrin, lamba-cyhalothrin, MCPA, prothioconazole, tebuconazole, metalaxyl, metalaxyl plus tebuconazole and prothioconazole, pinoxaden, pinoxaden plus cloquintocet, propiconazole, pyraclostrobin, pyroxasulfone, quinclorac, atrazine, acetochlor plus atrazine, trifloxystrobin, prothioconazole plus trifloxystrobin, metconazole, boscalid, atrazine plus mesotrione plus metolachlor S, bentazon, bentazon plus imazamox, boscalid plus prothioconazole, flucarbazone, metconazole-pyraclostrobin, metolachlor-s-metribuzin, saflufenacil, atrazine-metolachlor-s, fluroxypyr-2,4-d, flumioxazin, metconazole+pyraclostrobin 58.69%, fluroxypyr-florasulam-mcpa, prothioconazole-trifloxystrobin, pendimethalin, fluroxypyr-clopyralid-mcpa ester, fomesafen-metolachlor-s, prothioconazole-tebuconazole, quizalofop, ethalfluralin, fomesafen-glyphosate, tribenuron, isoxaflutole, thifensulfuron-tribenuron, bromoxynil-mcpa ester, topramezone, ethephon, fenoxaprop-p, pyroxsulam, prothioconazole+tebuconazole+metalaxyl, sulfentrazone, pyraclostrobin, thiencarbazone, bromoxynil-pyrasulfotole-thiencarbazone-methyl, pyrasulfotole-fenoxaprop-p-bromoxynil, bromoxynil-pyrasulfatole, bromoxynil-pyrasulfotole, pyrasulfotole-thiencarbazone- bromoxynil, tembotrione-thiencarbazone-methyl, isoxaflutole-thiencarbazone-methyl, and abamectin.

C. Formulation Types

Disclosed compositions can be formulated in a number of different ways, as will be understood by a person of ordinary skill in the art. See, for example, Manual on Development and Use of FAO Specifications for Plant Protection Products. Suitable formulations may depend on the exact active ingredient(s) used in the formulation, other components of such compositions, and/or the manner in which disclosed compositions are intended to be used to control unwanted vegetation. Exemplary formulations include:

dustable powders (DP), which can be prepared by mixing active compounds with one or more solid diluents (e.g. clays, kaolin, pyrophyllite, bentonite, alumina, montmorillonite, kieselguhr, chalk, diatomaceous earths, calcium phosphates, calcium and magnesium carbonates, sulphur, lime, flours, talc and other organic and inorganic solid carriers) followed by mechanically grinding the mixture to a fine powder;

soluble powders (SP) and water-soluble granules (SG), which can be prepared by mixing active compounds with one or more water-soluble inorganic salts (such as sodium bicarbonate, sodium carbonate or magnesium sulphate) a water-soluble organic solid (such as a polysaccharide) to form a mixture that is then ground to a fine powder;

water dispersible granules (WDG) and wettable powders (WP), which can be prepared by mixing active compounds with solid diluents or carriers, a wetting agent, a dispersing agent and/or a suspending agent, and grinding the mixture to a fine powder;

granules (GR) (slow or fast release), which can be formed either by granulating a mixture of actives, potentially in combination with a powdered solid diluent or carrier, or by absorbing active compounds (or a solution or suspension thereof in a suitable agent) in or onto a porous granular material (such as pumice, attapulgite clays, fuller's earth, kieselguhr, or diatomaceous earth), or a core material (such as sand, silicates, mineral carbonates, sulphates or phosphates). Formulation additives also may be included in granules (for example as an emulsifying agent, wetting agent or dispersing agent);

soluble concentrates (SL);

oil miscible liquids (OL);

ultra low volume liquids (UL);

emulsifiable concentrates (EC) or oil-in-water emulsions (EW), which can be prepared by dissolving an active compound or compounds in a suitable organic solvent (such as alkylbenzenes or alkylnaphthalenes), ketones (such as cyclohexanone or methylcyclohexanone), alcohols (such as benzyl alcohol, furfuryl alcohol or butanol), N-alkylpyrrolidones (such as N-methylpyrrolidone or N-octylpyrrolidone), dimethyl amides of fatty acids (such as C.sub.8-C.sub.10 fatty acid dimethylamide) and chlorinated hydrocarbons. An EC product may spontaneously emulsify on addition to water, to produce an emulsion with sufficient stability to allow spray application using appropriate equipment;

dispersible concentrates (DC), which can be prepared by dissolving one or more active compounds in water or an organic solvent, such as a ketone, alcohol or glycol ether;

emulsions [including oil in water (EW) and water in oil (EO) emulsions], which can be prepared by using one or more actives either as a liquid or in solution, and then emulsifying the resultant liquid or solution into water, potentially containing one or more surface active agents. Suitable solvents include vegetable oils, chlorinated hydrocarbons (such as chlorobenzenes), and aromatic solvents (such as alkylbenzenes or alkylnaphthalenes);

micro-emulsions (ME), which may be prepared by mixing water with a solvent or solvents, optionally with one or more surface active agents. An active compound or compounds is present initially in either the water or the solvent as described above for ECs or in EWs. A ME may be either an oil-in-water or a water-in-oil system, which can be determined using conductivity measurements).

suspension concentrates (SC), which comprise aqueous or non-aqueous suspensions of finely divided, insoluble solid particles of an active compound or compounds and may be prepared by ball or bead milling a solid active compound or compounds in a suitable medium to produce a fine particle suspension of the compound. One or more wetting agents and/or a suspending agent may be included to reduce particle settlement rate. An active compound or compounds also may be dry milled and added to water, optionally with other formulation agents, to produce the desired end product; and

aerosols, which comprise an active compound or compounds and a suitable propellant (for example a lower alkane, such as n-butane). An active compound or compounds also may be dissolved or dispersed in water or a water-miscible liquid, such as an alkyl alcohol, such as propanol, for use in spray pumps.

### VI. Method of Use

Disclosed embodiments concern using a combination or composition for controlling undesirable vegetation in crops. Disclosed method embodiments may comprise applying an herbicidal combination or composition according to the present invention to a locus of planted crops where undesirable vegetation occurs or might occur or to a locus where crops will be planted before planting or emergence of the crop. Application can be done before, during and/or after, preferably during and/or after, the emergence of the undesirable vegetation. Herbicides of the present disclosure, such as mesotrione and, oxyfluorfen, and any optional third or more co-herbicide, can be applied simultaneously, including as a premix, a diluted premix, or a tank mix, or in succession. The invention in particular relates to a method for controlling undesirable vegetation in crops comprising applying a disclosed composition comprising, or consisting of or consisting essentially of, herbicides of the present disclosure, such as mesotrione and oxyfluorfen, to a locus of planted crops where undesirable vegetation occurs or might occur or to a locus where crops will be planted before planting or emergence of the crop. The combination or composition also can be applied to a locus of planted crops which, by genetic engineering or by breeding, are resistant to one or more herbicides and/or pathogens such as plant-pathogenous fungi, and/or to attack by insects. Although certain exemplary embodiments are formulated as a premix comprising mesotrione and oxyfluorofen, a person of ordinary skill in the art will appreciate that mesotrione, oxyfluorofen, and the one or more optional co-herbicides, may be formulated jointly or separately and applied jointly or separately. Moreover, in the case of separate application, the order of application also may vary. However, when used as a combination, mesotrione herbicide and oxyfluorofen should be applied in a time frame that allows simultaneous action of the active ingredients on the undesirable plants.

Disclosed herbicidal combinations, such as compositions, according to the present application can be applied in any manner suitable as will be known to a person of ordinary skill in the art. For example, disclosed herbicidal compositions can be surface applied prior to planting, such as 45 days prior to planting.

Disclosed herbicidal combinations, such as compositions, according to the present application also can be preplant incorporated into soil after it is prepared for planting. Disclosed herbicidal combinations/compositions are incorporated to an effective soil depth, such as a depth of 1 to 2 inches. Herbicidal combinations/compositions according to the present invention can be used after crops are planted, such as by using a rolling cultivator.

Disclosed herbicidal combinations/compositions also can be used as a post emergence treatment when crops and weeds are actively growing and preferably before weeds are more than 3-inches tall. It can be beneficial to delay application of disclosed herbicidal combinations/compositions until the majority of weeds are at a specified growth stage. The timing of application preferably may be based on weed size as opposed to crop growth stage.

Furthermore, combinations/compositions according to the present invention can be applied in any manner, and for the same purposes, as are already known for mesotrione and oxyfluorfen. Mesotrione, for example, is a selective herbicide that can be applied to soil as an early pre-plant, pre-plant incorporated, pre-emergent or post-emergent treatment in various crops. The application method may depend upon the crop, anticipated weed spectrum and the preference of the applicator. For early pre-plant and pre-emergent treatments, susceptible weeds emerge, are present as stunted plants, and then die.

Certain disclosed embodiments of the present invention are systemic and selective pre-emergence and post-emergence herbicides for residual weed control. If used pre-emergence, weeds may take up the product through the soil during emergence. If used post-emergence, vulnerable weeds may take up the product through treated foliage and stop growing soon after application. For pre-emergence, suspension concentrates according to the present invention can be applied pre-emergence as a directed or shielded spray, and may be applied using a minimum carrier volume of 20 gallons/acre. For post-emergence, disclosed suspension concentrates according to the invention may be applied as a directed or shielded spray in a minimum spray volume of 40 gals./A with water as the carrier. Use a pump that will maintain pump pressure of 35-40 psi at the nozzles and provide proper agitation within the tank to keep the product dispersed. Lower pressures can be used with extended range or drift reduction nozzles. Non-ionic surfactants can be added to increase effectiveness. For example, 2 pints of 80% active nonionic surfactant maya be used per each 100 gallons of spray (0.25% v/v). Four pints of nonionic surfactant may enhance post-emergence activity when hard water (greater than 600 ppm minerals) is used.

Use a sprayer in good operating condition with good agitation. Ensure that the sprayer is cleaned prior to using disclosed compositions. For post-emergence applications, use clean water only for the spray solution. Ensure that all in-line strainers and nozzle screens in the sprayer are 50-mesh or coarser. Liquid fertilizers are generally preferred, as opposed to suspension fertilizers, as the carrier for pre-emergence applications. Start filling spray tank or pre-mix tank with clean water and begin agitation. Maintain constant agitation. When sprayer or pre-mix tank is half full of water, add disclosed compositions and agitate until achieve complete dispersion. If tank mixing, add the tank mix product. Add any desired surfactant, if needed, and continue to fill tank to desired level with water.

Disclosed herbicidal combinations can be used to control weeds for a number of crops, such as: citrus fruit, including Australian desert lime, Australian finger lime, Australian round lime, Brown River finger lime, calamondin, citron, citrus hybrids, grapefruit, Japanese summer grapefruit, kumquat, lemon, lime, Mediterranean mandarin, Mount white lime, New Guinea wild lime, sour orange, sweet orange, pummelo, Russell River lime, Satsuma mandarin, sweet lime, Tachibana orange, Tahiti lime, tangelo, tangerine (Mandarin), tangor, trifoliate orange, uniq fruit, cultivars, varieties and/or hybrids of these; stone fruits, such as apricot, Japanese apricot, Chinese jujube, nectarine, peach, plum, American plum, beach plum, Canada plum, cherry plum, Chickasaw plum, Damson plum, Japanese plum, Klamath plum, prune plum, plumcot, sloe, cultivars, varieties and/or hybrids of these; tree nuts, such as African nut-tree, almond, beech nut, Brazil nut, Brazilian pine, bunya, bur oak, butternut, Cajou nut, candlenut, cashew, chestnut, chinquapin, coconut, Coquito nut, Dika nut, ginkgo, Guiana chestnut, hazelnut (filbert), heartnut, hickory nut, Japanese horse-chestnut, macadamia nut, mongongo nut, monkey-pot, monkey puzzle nut, Okari nut, Pachira nut, peach palm nut, pecan, pequi, pili nut, pine nut, pistachio, Sapucaia nut, tropical almond, black walnut, English walnut, yellowhorn, cultivars, varieties and/or hybrids of these. Disclosed herbicidal combinations may be applied in combination with most commonly used herbicides registered for use in citrus, stone fruits and tree nuts. These tank mixtures can be used to help control or manage the development of resistant weeds. The application of mixtures or sequences of effective herbicides, with different sites of action, provides diverse management of herbicide resistance.

### EXAMPLES

The following examples are provided to exemplify certain features of the presently disclosed embodiments. A person of ordinary skill in the art will appreciate that the scope of the invention is not limited to these specific features.

### Example 1

This example concerns one embodiment of a composition according to the present invention and a method for making the composition. This particular embodiment of a disclosed formulation had the composition stated below in Table 1 and a density of 1.20 g/ml.

TABLE 1
A MESOTRIONE/OXYFLUORFEN COMBINATION

| | Amount Ranges | | |
|---|---|---|---|
| Component | (wt. %) | Average | Function |
| Oxyfluorfen | 35-38% | 37% | Active |
| (technical, | | | Ingredient |
| 96%) | | | |
| Mesotrione | 4-5% | 4.5% | Active |
| (technical, | | | Ingredient |
| 98.3%) | | | |
| Agent SCB1 | 2.5-3.5% | 3% | Surfactant |
| Glycerol | 11-13% | 12% | Freeze/ |
| | | | thaw agent |
| SAG 1572 | 0.15-0.25% | 0.2% | Defoamer |
| (poly- | | | |
| dimethyl- | | | |
| siloxane | | | |
| antifoam | | | |
| emulsion) | | | |
| Kelzan | 0.1-0.2% | 0.15% | Rheology |
| S Plus | | | aid |
| (xanthan | | | |
| gum) | | | |
| Proxel GXL | 0.1-0.2% | 0.15% | Anti- |
| (20% | | | microbial |
| aqueous | | | |
| dipropylene | | | |
| glycol | | | |
| solution of | | | |
| 1,2-benziso- | | | |
| thiazolin-3- | | | |
| one) | | | |
| Water | 14-45% | 43.1% | Carrier |
| | | 100% | |
| | | (weight) | |

Surfactant, glycerol and approximately one third of the required water were weighed into a tank. Surfactant and glycerol may be combined first, if needed, to avoid gelling. These ingredients were agitated (at 400 rpm) for a few minutes until well mixed. Mesotrione and oxyfluorfen were then added to the tank with continued mixing. Mixing was then discontinued. The remaining components were then added, followed by high shear mixing (723 RPM).

### Example 2

This example concerns trials that were conducted using a formulation according to Example 1, together with controls. The testing protocol is provided below by Table 2. Treatment 5 was a tank mix composition, whereas treatments 6 and 7 were concentrates according to Example 1 comprising mesotrione and oxyfluorfen.

TABLE 2
MESOTRIONE/OXYFLUORFEN COMBINATION
TRIAL PROTOCOL-NON-DESTRUCT TRIAL

| | TREATMENT |
|---|---|
| PROTOCOL TREATMENTS | RATE |
| 1. Control | No herbicide |
| 2. Mesotrione | 4 fluid ounces/acre |
| 3. Mesotrione | 6 fluid ounces/acre |
| 4. Oxyfluorfen | 48 fluid ounces/acre |
| 5. Mesotrione (6 fluid ounces) + | 48 fluid ounces/acre |
| Oxyflo (48 fluid ounces) | |
| 6. Composition according | 36 fluid ounces/acre |
| to Example 1 | |
| 7. Composition according | 54 fluid ounces/acre |
| to Example 1 | |

At the time of application, weeds should be less than or equal to 4 inches in height. To acquire useful information, users note all weed species, sizes, and weed population per square meter at the treatment application locus, and plot photographs also are taken. For post emergence weed control information, data is recorded at least at 14 and 28 days after treatment, and photographs are taken after one replication. For preemergence weed control information, data is recorded at least at 45 and 60 days after treatment, and photographs are taken after one replication.

### Example 3

This trial was conducted in a pistachio orchard in Sanger, Calif. The treatments were as stated below by Table 3.

TABLE 3

| TRT. | TREATMENT | | RATE |
|---|---|---|---|
| NO. | NAME | RATE | UNIT |
| 1 | UTC | | |
| 2 | Mesotrione 4SC | 4 | fl oz/a |
| | NIS | 0.25 | % v/v |
| 3 | Mesotrione 4SC | 6 | fl oz/a |
| | Nonionic surfactant | 0.25 | % v/v |
| 4 | Oxyfluorfen | 48 | fl oz/a |
| | Nonionic surfactant | 0.25 | % v/v |
| 5 | Mesotrione 4SC | 4 | fl oz/a |
| | Oxyfluorfen | 48 | fl oz/a |
| | Nonionic surfactant | 0.25 | % v/v |
| 6 | Mesotrione 4SC | 6 | fl oz/a |
| | Oxyfluorfen | 48 | fl oz/a |
| | Nonionic surfactant | 0.25 | % v/v |

Photographs of the treated plots clearly establish that, at day 7 following application, treatments 5 and 6 provided significantly more burndown amongst all weed species compared to the control and the standalone treatments. At fifteen days after the initial application, the Mesotrione and Oxyfluorfen combinations, treatments 5 and 6, provided significantly more burndown control than the control, as well as treatments 2-4. Forty-six and sixty days after the initial application, treatments 5-6 provided significantly better residual control, with treatment 5 providing the best residual control.

### Example 4

The trial was performed in an almond orchard on an almond variety known as Monterey in Chowchilla, Calif. The almonds were 3 years old at the time of the trials. The trees were spaced 16 feet apart from each other, and the rows were spaced 22 feet apart. The trial was a Randomized Complete Block Design replicated 4 times. Each plot had three trees, and was 48 feet long by 10 feet wide, for a total plot area of 480 square feet. Each treatment was 1,920 square feet and had a total acreage of 0.0441 acres. The width of the plot was based on the length of the boom.

Mesotrione 4SC and oxyfluorfen 4SC were applied as solo treatments, as a tank mix, and as a premix concentrate referred to as Mesoflo SC herbicide. Mesoflo was applied at two rates, namely 36 fluid ounces and fluid ounces. Weed control efficacy was compared among these treatments. Overall, Mesoflo SC herbicide treatments showed better weed control over tank mix and solo treatments.

The six treatments used are as stated below by Table 4.

TABLE 4

| TRT. | | TRT. | | RATE | APPL | APPL | AMOUNT | MIX | MIX |
|---|---|---|---|---|---|---|---|---|---|
| NO. | TYPE | NAME | RATE | UNIT | CODE | AMT. | SIZE | SIZE | UNIT |
| 1 | Chk | Untreated | | | | | | | |
| | | Check | | | | | | | |
| 2 | HERB | Mesotrione | 6 | fl oz/a | A | 30 | GAL/AC | 5.8 | L |
| | ADJ | 4 SC | 0.25 | % v/v | A | 30 | GAL/AC | 5.8 | L |
| | | Dyne-Amic | | | | | | | |
| 3 | HERB | OxyFlo 4 | 48 | fl oz/a | A | 30 | GAL/AC | 5.8 | L |
| | ADJ | SC | 0.25 | % v/v | A | 30 | GAL/AC | 5.8 | L |
| | | Dy ne-Amic | | | | | | | |
| 4 | HERB | Mesotrione | 6 | fl oz/a | A | 30 | GAL/AC | 5.8 | L |
| | ADJ | 4 SC | 48 | fl oz/a | A | 30 | GAL/AC | 5.8 | L |
| | | OxyFlo 4 | 0.25 | % v/v | | | GAL/AC | | |
| | | SC | | | | | | | |
| | | Dyne Amic | | | | | | | |
| 5 | HERB | MesoFlo SC | 36 | fl oz/a | A | 30 | GAL/AC | 5.8 | L |
| | ADJ | Dy ne-Amic | 0.25 | % v/v | A | 30 | GAL/AC | 5.8 | L |
| 6 | HERB | MesoFlo SC | 54 | fl oz/a | A | 30 | GAL/AC | 5.8 | L |
| | ADJ | Dy ne-Amie | 0.25 | % v/v | A | 30 | GAL/AC | 5.8 | L |

The trial was initiated in March when Hairy Fleabane [Conyza bonariensis], Little Mallow [Malva parviflora], Common Chickweed [Stellaria media], Annual Bluegrass [Poa annua], and Redstem Filaree [Erodium cicutarium] were emerged and established in the orchard. The weeds were less than 4 inches tall or wide at the time of application. Each application was delivered using a 5-foot, 3-nozzle spray boom equipped with two Tee-Jet 11002 VS Flat-Fan nozzles and one Tee-Jet OC-02 kick-out nozzle to assure thorough coverage of the berm. The application had a mix size of 5.8 liters and was delivered at 30 gallons per acre. The spray was propelled by CO₂ at a pressure of 30 PSI. The boom was calibrated to output 1.8 liters per minute for the application. The applicator was spraying at 1.57 miles per hour.

One week after initial application, a burndown weed control evaluation was conducted. The burndown efficacy evaluation was collected on an individual weed species basis from each plot. The burndown evaluation was based on a 0-100% scale in comparison to the untreated. A rating of 0 represented a weed that was not burned down, similar to the untreated. A rating of 100 represented a weed that was completely burned down and dead. Subsequent burndown efficacy evaluations were conducted 14 days (2 weeks) and 28 days (4 weeks) after initial application. Phytotoxicity evaluations were also conducted 7 and 14 days after the initial application. Phytotoxicity was conducted by observing the untreated plots first and then checking the treated plots for any visible differences on the foliage. The phytotoxicity evaluations were rated on a 0-100% scale.

Six weeks after initial application, an emergence evaluation for residual control was conducted. The individual weed species from each plot were evaluated on a 0-100% for residual weed control. The treated plots were compared to the weed emergence coverage in the untreated plots. A rating of 0 represented a plot that was completely infested with weeds, similar to the untreated. A rating of 100 represented a plot that did not have any weeds present. A subsequent emergence evaluation was conducted 56 days (8 weeks) after the application.

Seven days after the application, treatments 3-6 provided significantly more rapid burndown amongst all weed species compared to the standalone Mesotrione treatment (Treatment 2). Furthermore, the high rate of MesoFlo (Treatment 6) significantly provided the best rapid burndown control of Annual Bluegrass and Hairy Fleabane compared to the other treatments. There was also an obvious rate response amongst the MesoFlo treatments, as the high rate had a higher rate of burndown across all weed species compared to the low rate. However, the tank-mix of Mesotrione and OxyFlo (Treatment 4) significantly provided the best rapid burndown control of Redstem Filaree compared to the other treatments.

Fourteen days after the initial application, the tank-mix of Mesotrione and OxyFlo (treatment 4) and the pre-mix, MesoFlo (Treatment 5 & 6), provided significantly more burndown control amongst Annual Bluegrass, Common Chickweed, and Hairy Fleabane compared to the standalone treatments, Mesotrione (Treatment 2) and OxyFlo (Treatment 3). The high rate of MesoFlo (Treatment 6) continued to significantly provide the best burndown control of Annual Bluegrass compared to the other treatments. It was also apparent that MesoFlo (Treatments 5 & 6) numerically controlled Hairy Fleabane better than the tank-mix of Mesotrione and OxyFlo (Treatment 4).

Twenty-eight days after the initial application, the high rate of MesoFlo (Treatment 6) significantly provided the best burndown control of Annual Bluegrass, Common Chickweed, and Hairy Fleabane compared to the other treatments. However, Annual Bluegrass and Redstem Filaree regrowth was observed in all treatments.

Forty-two and fifty-six days after the initial application, treatments 3-6 provided significantly better residual control of Annual Bluegrass, Little Mallow, and Redstem Filaree compared to the standalone Mesotrione treatment (Treatment 2). The tank-mix of Mesotrione and OxyFlo (treatment 4) and the pre-mix, MesoFlo (Treatment 5 & 6) provided 95-100% residual control of Common Chickweed, Hairy Fleabane, and Little Mallow. The high rate of MesoFlo (Treatment 6) numerically provided the best residual control of Annual Bluegrass. Whereas, the tank-mix of Mesotrione and OxyFlo (Treatment 4) significantly provided the best residual control of Redstem Filaree compared to the other treatments.

Overall, no issues were encountered during the mixing or application process. No phytotoxicity was observed throughout the duration of the trial.

In conclusion, the high rate of MesoFlo (Treatment 6) consistently provided the best burndown control of Annual Bluegrass, Common Chickweed, and Hairy Fleabane. There was also a definite rate response amongst the MesoFlo treatments as well. The 54 fluid ounce/acre rate consistently provided better control than the 36 fluid ounce/acre rate. Additionally, the tank-mix of Mesotrione and OxyFlo (treatment 4) and the pre-mix, MesoFlo (Treatment 5 & 6) had the best residual control of Common Chickweed, Hairy Fleabane, and Little Mallow compared to the standalone Mesotrione and OxyFlo treatments.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. An herbicidal combination, comprising:
a triketone herbicide having a formula 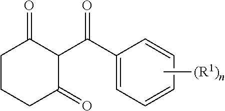
wherein n=1, 2 or 3, and R¹ is selected from halogen, nitro (—NO₂), or —SO₂R² where R² is lower alkyl, trihaloalkyl and trihaloalkoxy; and
a diphenylether herbicide having a formula 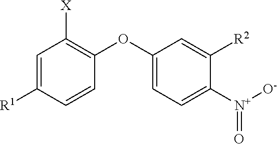
wherein R¹ is C₁₋₆ alkyl or C₁₋₆ haloalkyl, X is halogen, R² is —CO₂H, or salts thereof, CO₂R³ or —CHCH₃CO₂R³ where R³ is C₁₋₆ alkyl, ether, or amidosulfonyl.

2. The combination according to any claim 1 where the combination is a premix concentrate or a tank mix composition.

3. The combination according to claim 1 wherein, with reference to the triketone herbicide, R¹ is Cl, —CF₃, —SO₂CH₃, and/or —CH₂OCH₂CF₃.

4. The combination according to claim 1 wherein the triketone herbicide has a formula

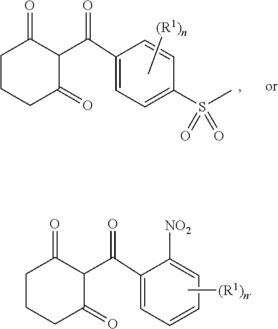

5. The combination according to claim 1 wherein the triketone herbicide is selected from 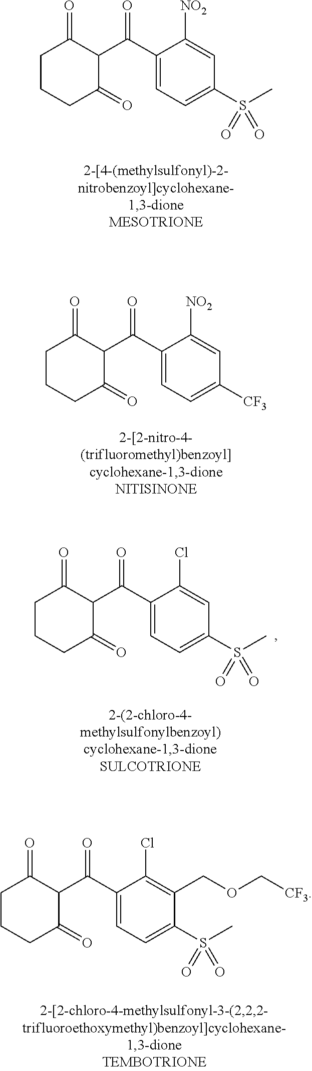 [SMILES: CS(=O)(=O)c1ccc(C(=O)C2C(=O)CCCC2=O)c([N+](=O)[O-])c1 ; O=C1CCCC(=O)C1C(=O)c1ccc(C(F)(F)F)cc1[N+](=O)[O-] ; CS(=O)(=O)c1ccc(C(=O)C2C(=O)CCCC2=O)c(Cl)c1 ; CS(=O)(=O)c1ccc(C(=O)C2C(=O)CCCC2=O)c(Cl)c1COCC(F)(F)F]
or

6. The combination according to claim 1 wherein the triketone herbicide is mesotrione.

7. The combination according to claim 1 wherein, with reference to the diphenylether, R¹ is trifluoromethyl (—CF₃), X is Cl, and R² is ethyl ether (—OCH₂CH₃).

8. The combination according to claim 1 wherein, with reference to the diphenylether, R² is 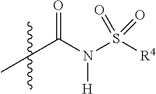
and R⁴ is methyl.

9. The combination according to claim 1 wherein, with reference to the diphenylether, R² is

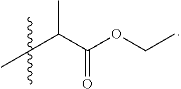 [SMILES: *C(C)C(=O)OCC]

10. The combination according to claim 1 wherein the diphenylether herbicide is selected from

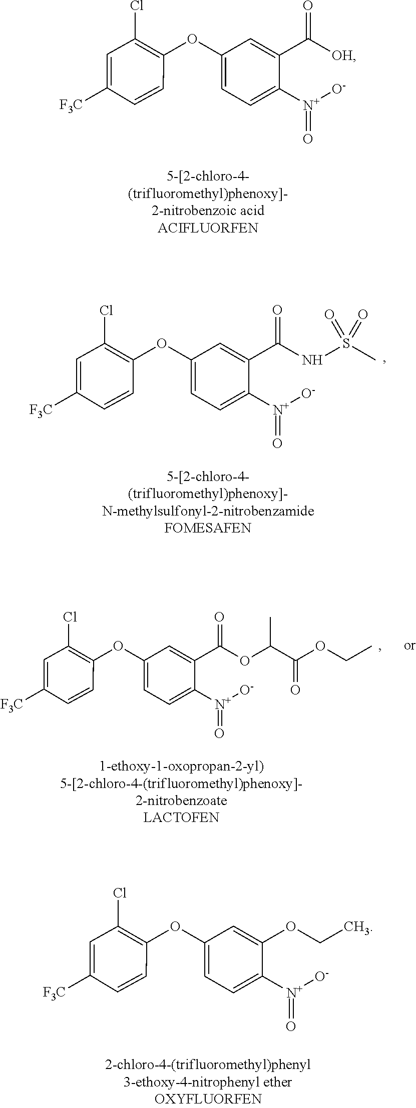 [SMILES: O=C(O)c1cc(Oc2ccc(C(F)(F)F)cc2Cl)ccc1[N+](=O)[O-] ; CS(=O)(=O)NC(=O)c1cc(Oc2ccc(C(F)(F)F)cc2Cl)ccc1[N+](=O)[O-] ; CCOC(=O)C(C)OC(=O)c1cc(Oc2ccc(C(F)(F)F)cc2Cl)ccc1[N+](=O)[O-] ; CCOc1cc(Oc2ccc(C(F)(F)F)cc2Cl)ccc1[N+](=O)[O-]]

11. The combination according to claim 1 wherein the diphenylether herbicide is oxyfluorfen.

12. The combination according to claim 1 further comprising an anionic surface active agent, an antifoaming/defoaming agent, an anti-freeze agent, a cationic surface active agent, a co-herbicide, a dispersing agent, a filler, a fertilizer, a liquid carrier, a non-ionic surface active agent, a microbiocidal agent, a pH adjustor, a preservative, a rheology aid, a safener, a solid carrier, a solvent, a co-solvent, a spray additive, a surfactant, a suspending agent, a wetting agent, and any and all combinations thereof.

13. The combination according to claim 12 wherein the co-herbicide is a lipid biosynthesis inhibitor, an ALS inhibitor, a photosynthesis inhibitor, a protoporphyrinogen-IX-oxidase inhibitor, a bleacher-herbicide based on inhibition of carotenoid biosynthesis, an EPSP synthase inhibitor, a glutamine synthetase inhibitor, a DHP synthase inhibitor, a mitosis inhibitor, a VLCFA inhibitor based on inhibiting synthesis of long chain fatty acids, a cellulose biosynthesis inhibitor, a de-coupler herbicide based on disrupting cell membranes, an auxinic herbicide, and an auxin transport inhibitor.

14. The combination according to claim 12, wherein the co-herbicide is selected from aclonifen, acrolein, azafenidin, azimsulfuron, asulam, acetochlor, atrazine, anilofos, amicarbazone, amidosulfuron, amitrole, aminocyclopyrachlor, aminopyralid, amiprofos-methyl, ametryn, alachlor, alloxydim, ancymidol, isouron, isoxachlortole, isoxaflutole, isoxaben, Isodecylalkoholethoxylat, isoproturon, ipfencarbazone, imazaquin, imazapic (including salts such as amine), imazapyr (including salts such as isopropylamine), imazamethabenz-methyl, imazamox, imazosulfuron, indaziflam, indanofan, eglinazine-ethyl, esprocarb, ethametsulfuron-methyl, ethalfluralin, ethidimuron, ethoxysulfuron, ethoxyfen-ethyl, ethofumesate, etobenzanid, endothal-disodium, oxadiazon, oxadiargyl, oxaziclomefone, oxasulfuron, oxyfluorfen, oryzalin, orthosulfamuron, orbencarb, oleic acid, cafenstrole, carfentrazone-ethyl, karbutilate, carbetamide, quizalofop, quizalofop-ethyl, quizalofop-P-ethyl, quizalofop-P-tefuryl, quinoclamine, quinclorac, quinmerac, cumyluron, clacyfos, glyphosate (including salts such as sodium, potassium, amine, propylamine, isopropylamine, dimethylamine or trimesium), glufosinate (including salts such as amine or sodium), glufosinate-P, glufosinate-P-sodium, clethodim, clodinafop-propargyl, clopyralid, clomazone, chlomethoxyfen, clomeprop, cloransulam-methyl, chloramben, chloridazon, chlorimuron-ethyl, chlorsulfuron, chlorthal-dimethyl, chlorthiamid, chlorphthalim, chlorflurenol-methyl, chlorpropham, chlorbromuron, chloroxuron, chlorotoluron, ketospiradox (including salts such as sodium, calcium, or ammonia), saflufenacil, sarmentine, cyanazine, cyanamide, diuron, diethatyl-ethyl, dicamba (including salts such as amine, diethylamine, isopropylamine, diglycolamine, sodium or lithium), cycloate, cycloxydim, diclosulam, cyclosulfamuron, cyclopyrimorate, dichlobenil, diclofop-P-methyl, diclofop-methyl, dichlorprop, dichlorprop-P, diquat, dithiopyr, siduron, dinitramine, cinidon-ethyl, cinosulfuron, dinoseb, dinoterb, cyhalofop-butyl, diphenamid, difenzoquat, diflufenican, diflufenzopyr, simazine, dimethachlor, dimethametryn, dimethenamid, dimethenamid-P, simetryn, dimepiperate, dimefuron, cinmethylin, swep, sulfentrazone, sulfosate, sulfosulfuron, sulfometuron-methyl, sethoxydim, terbacil, daimuron, thaxtomin A, dalapon, thiazopyr, tiafenacil, thiencarbazone (including sodium salt, methyl ester or the like), tiocarbazil, thiobencarb, thidiazimin, thidiazuron, thifensulfuron-methyl, desmedipham, desmetryne, thenylchlor, tebutam, tebuthiuron, tepraloxydim, tefuryltrione, terbuthylazine, terbutryn, terbumeton, topramezone, tralkoxydim, triaziflam, triasulfuron, triafamone, tri-allate, trietazine, triclopyr, triclopyr-butotyl, tritosulfuron, trifludimoxazin, triflusulfuron-methyl, trifluralin, trifloxysulfuron-sodium, tribenuron-methyl, tolpyralate, naptalam (including salts such as sodium), naproanilide, napropamide, napropamide-M, nicosulfuron, neburon, norflurazon, vernolate, paraquat dichloride, halauxifen-benzyl, halauxifen-methyl, haloxyfop, haloxyfop-P, haloxyfop-etotyl, halosafen, halosulfuron-methyl, picloram, picolinafen, bicyclopyrone, bispyribac-sodium, pinoxaden, bifenox, piperophos, pyraclonil, pyrasulfotole, pyrazoxyfen, pyrazosulfuron-ethyl, pyrazolynate, bilanafos, pyraflufen-ethyl, pyridafol, pyrithiobac-sodium, pyridate, pyriftalid, pyributicarb, pyribenzoxim, pyrimisulfan, pyriminobac-methyl, pyroxasulfone, pyroxsulam, phenisopham, fenuron, fenoxasulfone, fenoxaprop (including methyl, ethyl and isopropyl ester), fenoxaprop-P (including methyl, ethyl and isopropyl ester), fenthiaprop-ethyl, fentrazamide, phenmedipham, foramsulfuron, butachlor, butafenacil, butamifos, butylate, butenachlor, butralin, butroxydim, flazasulfuron, flamprop (including methyl, ethyl and isopropyl ester), flamprop-M (including methyl, ethyl and isopropyl ester), primisulfuron-methyl, fluazifop-butyl, fluazifop-P-butyl, fluazolate, fluometuron, fluoroglycofen-ethyl, flucarbazone-sodium, fluchloralin, flucetosulfuron, fluthiacet-methyl, flupyrsulfuron-methyl (including salts such as sodium, calcium or ammonia), flufenacet, flufenpyr-ethyl, flupropanate, flupoxame, flumioxazin, flumiclorac-pentyl, flumetsulam, fluridone, flurtamone, fluroxypyr (including esters such as butomethyl and meptyl, and salts such as sodium, calcium or ammonia), flurochloridone, pretilachlor, procarbazone-sodium, prodiamine, prosulfuron, prosulfocarb, propaquizafop, propachlor, propazine, propanil, propisochlor, propyrisulfuron, propham, profluazol, prohexadione-calcium, propoxycarbazone, propoxycarbazone-sodium, profoxydim, bromacil, brompyrazon, prometryn, prometon, bromoxynil (including esters such as butyric acid, octanoic acid or heptanoic acid), bromofenoxim, bromobutide, florasulam, florpyrauxifen, florpyrauxifen-benzyl, ioxynil, hexazinone, pethoxamid, benazolin, penoxsulam, heptamaloxyloglucan, beflubutamid, pebulate, pelargonic acid, bencarbazone, pendimethalin, benzfendizone, bensulide, bensulfuron-methyl, benzobicyclon, benzofenap, bentazone, pentanochlor, pentoxazone, benfluralin, benfuresate, fosamine, foramsulfuron, forchlorfenuron, mecoprop (including salts such as sodium, potassium, isopropylamine, triethanolamine or dimethylamine), mecoprop-P-potassium, mesosulfuron (including esters such as methyl), metazachlor, metazosulfuron, methabenzthiazuron, metamitron, metamifop, metam, DSMA, methiozolin, methyldymuron, metoxuron, metosulam, metsulfuron-methyl, metobromuron, metobenzuron, metolachlor, metribuzin, mepiquat chloride, mefenacet, monosulfuron (including methyl, ethyl and isopropyl ester), monolinuron, molinate, iodosulfuron, iodosulfulon-methyl-sodium, iofensulfuron, iofensulfuron-sodium, lancotrione, linuron, rimsulfuron, lenacil, TCA (including salts such as sodium, calcium or ammonia), 2,3,6-TBA, 2,4,5-T, 2,4-D (including salts such as amine, diethylamine, triethanolamine, isopropylamine, sodium or lithium), ACN, AE-F-150944 (Code number), MCPA, MCPB (including sodium salt, ethyl ester or the like), 2,4-DB, DNOC (including salts such as amine or sodium), MCPA-thioethyl, IR-6396 (Code number), SYP-298 (Code number), SYP-300 (Code number), EPTC, S-metolachlor, S-9750 (Code number), MSMA, and HW-02 (Code number), as well as salts and analogues of these compounds; 2,3,6-TBA, 2,3,6-TBA-dimethylammonium, 2,3,6-TBA-sodium, 2,4,5-T, 2,4,5-T-2-butoxypropyl, 2,4,5-T-2-ethylhexyl, 2,4,5-T-3-butoxypropyl, 2,4,5-TB, 2,4,5-T-butometyl, 2,4,5-T-butotyl, 2,4,5-T-butyl, 2,4,5-T-isobutyl, 2,4,5-T-isoctyl, 2,4,5-T-isopropyl, 2,4,5-T-methyl, 2,4,5-T-pentyl, 2,4,5-T-sodium, 2,4,5-T-triethylammonium, 2,4,5-T-trolamine, 2,4-D, 2,4-D-2-butoxypropyl, 2,4-D-2-ethylhexyl, 2,4-D-3-butoxypropyl, 2,4-D-ammonium, 2,4-DB, 2,4-DB-butyl, 2,4-DB-dimethylammonium, 2,4-DB-isoctyl, 2,4-DB-potassium, 2,4-DB-sodium, 2,4-D-butotyl, 2,4-D-butyl, 2,4-D-diethylammonium, 2,4-D-dimethylammonium, 2,4-D-diolamine, 2,4-D-dodecylammonium, 2,4-DEB, 2,4-DEP, 2,4-D-ethyl, 2,4-D-heptylammonium, 2,4-D-isobutyl, 2,4-D-isoctyl, 2,4-D-isopropyl, 2,4-D-isopropylammonium, 2,4-D-lithium, 2,4-D-meptyl, 2,4-D-methyl, 2,4-D-octyl, 2,4-D-pentyl, 2,4-D-potassium, 2,4-D-propyl, 2,4-D-sodium, 2,4-D-tefuryl, 2,4-D-tetradecylammonium, 2,4-D-triethylammonium, 2,4-D-tris(2-hydroxypropyl)ammonium, 2,4-D-trolamine, 3,4-DA, 3,4-DB, 3,4-DP, 4-CPA, 4-CPB, 4-CPP, acetochlor, aclonifen, acrolein, alachlor, allidochlor, alloxydim, alloxydim-sodium, allyl alcohol, alorac, ametridione, ametryn, amibuzin, amicarbazone, amidosulfuron, aminocyclopyrachlor, aminocyclopyrachlor-methyl, aminocyclopyrachlor-potassium, aminopyralid, aminopyralid-potassium, aminopyralid-tris(2-hydroxypropyl)ammonium, amiprofos-methyl, amitrole, ammonium sulfamate, anilofos, anisuron, asulam, asulam-potassium, asulam-sodium, atraton, atrazine, azafenidin, azimsulfuron, aziprotryne, barban, BCPC, beflubutamid, benazolin, benazolin-dimethylammonium, benazolin-ethyl, benazolin-potassium, bencarbazone, benfluralin, benfuresate, bensulfuron, bensulfuron-methyl, bensulide, bentazone, bentazone-sodium, benzadox, benzadox-ammonium, benzfendizone, benzipram, benzobicyclon, benzofenap, benzofluor, benzoylprop, benzoylprop-ethyl, benzthiazuron, bicyclopyrone, bifenox, bilanafos, bilanafos-sodium, bispyribac, bispyribac-sodium, borax, bromacil, bromacil-lithium, bromacil-sodium, bromobonil, bromobutide, bromofenoxim, bromoxynil, bromoxynil butyrate, bromoxynil heptanoate, bromoxynil octanoate, bromoxynil-potassium, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole, carfentrazone, carfentrazone-ethyl, CDEA, CEPC, chlomethoxyfen, chloramben, chloramben-ammonium, chloramben-diolamine, chloramben-methyl, chloramben-methylammonium, chloramben-sodium, chloranocryl, chlorazifop, chlorazifop-propargyl, chlorazine, chlorbromuron, chlorbufam, chloreturon, chlorfenac, chlorfenac-sodium, chlorfenprop, chlorfenprop-methyl, chlorflurazole, chlorflurenol, chlorflurenol-methyl, chloridazon, chlorimuron, chlorimuron-ethyl, chlornitrofen, chloropon, chlorotoluron, chloroxuron, chloroxynil, chlorprocarb, chlorpropham, chlorsulfuron, chlorthal, chlorthal-dimethyl, chlorthal-monomethyl, chlorthiamid, cinidon-ethyl, cinmethylin, cinosulfuron, cisanilide, clethodim, cliodinate, clodinafop, clodinafop-propargyl, clofop, clofop-isobutyl, clomazone, clomeprop, cloprop, cloproxydim, clopyralid, clopyralid-methyl, clopyralid-olamine, clopyralid-potassium, clopyralid-tris(2-hydroxypropyl)ammonium, cloransulam, cloransulam-methyl, CMA, copper sulfate, CPMF, CPPC, credazine, cresol, cumyluron, cyanamide, cyanatryn, cyanazine, cycloate, cyclosulfamuron, cycloxydim, cycluron, cyhalofop, cyhalofop-butyl, cyperquat, cyperquat chloride, cyprazine, cyprazole, cypromid, daimuron, dalapon, dalapon-calcium, dalapon-magnesium, dalapon-sodium, dazomet, dazomet-sodium, delachlor, desmedipham, desmetryn, di-allate, dicamba, dicamba-dimethylammonium, dicamba-diolamine, dicamba-isopropylammonium, dicamba-methyl, dicamba-olamine, dicamba-potassium, dicamba-sodium, dicamba-trolamine, dichlobenil, dichloralurea, dichlormate, dichlorprop, dichlorprop-2-ethylhexyl, dichlorprop-butotyl, dichlorprop-dimethylammonium, dichlorprop-ethylammonium, dichlorprop-isoctyl, dichlorprop-methyl, dichlorprop-P, dichlorprop-P-dimethylammonium, dichlorprop-potassium, dichlorprop-sodium, diclofop, diclofop-methyl, diclosulam, diethamquat, diethamquat dichloride, diethatyl, diethatyl-ethyl, difenopenten, difenopenten-ethyl, difenoxuron, difenzoquat, difenzoquat metilsulfate, diflufenican, diflufenzopyr, diflufenzopyr-sodium, dimefuron, dimepiperate, dimethachlor, dimethametryn, dimethenamid, dimethenamid-P, dimexano, dimidazon, dinitramine, dinofenate, dinoprop, dinosam, dinoseb, dinoseb acetate, dinoseb-ammonium, dinoseb-diolamine, dinoseb-sodium, dinoseb-trolamine, dinoterb, dinoterb acetate, diphacinone-sodium, diphenamid, dipropetryn, diquat, diquat dibromide, disul, disul-sodium, dithiopyr, diuron, DMPA, DNOC, DNOC-ammonium, DNOC-potassium, DNOC-sodium, DSMA, EBEP, eglinazine, eglinazine-ethyl, endothal, endothal-diammonium, endothal-dipotassium, endothal-disodium, epronaz, EPTC, erbon, esprocarb, ethalfluralin, ethametsulfuron, ethametsulfuron-methyl, ethidimuron, ethiolate, ethofumesate, ethoxyfen, ethoxyfen-ethyl, ethoxysulfuron, etinofen, etnipromid, etobenzanid, EXD, fenasulam, fenoprop, fenoprop-3-butoxypropyl, fenoprop-butometyl, fenoprop-butotyl, fenoprop-butyl, fenoprop-isoctyl, fenoprop-methyl, fenoprop-potassium, fenoxaprop, fenoxaprop-ethyl, fenoxaprop-P, fenoxaprop-P-ethyl, fenoxasulfone, fenteracol, fenthiaprop, fenthiaprop-ethyl, fentrazamide, fenuron, fenuron TCA, ferrous sulfate, flamprop, flamprop-isopropyl, flamprop-M, flamprop-methyl, flamprop-M-isopropyl, flamprop-M-methyl, flazasulfuron, florasulam, fluazifop, fluazifop-butyl, fluazifop-methyl, fluazifop-P, fluazifop-P-butyl, fluazolate, flucarbazone, flucarbazone-sodium, flucetosulfuron, fluchloralin, flufenacet, flufenican, flufenpyr, flufenpyr-ethyl, flumetsulam, flumezin, flumiclorac, flumiclorac-pentyl, flumioxazin, flumipropyn, fluometuron, fluorodifen, fluoroglycofen, fluoroglycofen-ethyl, fluoromidine, fluoronitrofen, fluothiuron, flupoxam, flupropacil, flupropanate, flupropanate-sodium, flupyrsulfuron, flupyrsulfuron-methyl-sodium, fluridone, flurochloridone, fluroxypyr, fluroxypyr-butometyl, fluroxypyr-meptyl, flurtamone, fluthiacet, fluthiacet-methyl, foramsulfuron, fosamine, fosamine-ammonium, furyloxyfen, glufosinate, glufosinate-ammonium, glufosinate-P, glufosinate-P-ammonium, glufosinate-P-sodium, glyphosate, glyphosate-diammonium, glyphosate-dimethylammonium, glyphosate-isopropylammonium, glyphosate-monoammonium, glyphosate-potassium, glyphosate-sesquisodium, glyphosate-trimesium, halosafen, halosulfuron, halosulfuron-methyl, haloxydine, haloxyfop, haloxyfop-etotyl, haloxyfop-methyl, haloxyfop-P, haloxyfop-P-etotyl, haloxyfop-P-methyl, haloxyfop-sodium, hexachloroacetone, hexaflurate, hexazinone, imazamethabenz, imazamethabenz-methyl, imazamox, imazamox-ammonium, imazapic, imazapic-ammonium, imazapyr, imazapyr-isopropylammonium, imazaquin, imazaquin-ammonium, imazaquin-methyl, imazaquin-sodium, imazethapyr, imazethapyr-ammonium, imazosulfuron, indanofan, indaziflam, iodobonil, iodomethane, iodosulfuron, iodosulfuron-methyl-sodium, ioxynil, ioxynil octanoate, ioxynil-lithium, ioxynil-sodium, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lenacil, linuron, MAA, MAMA, MCPA, MCPA-2-ethylhexyl, MCPA-butotyl, MCPA-butyl, MCPA-dimethylammonium, MCPA-diolamine, MCPA-ethyl, MCPA-isobutyl, MCPA-isoctyl, MCPA-isopropyl, MCPA-methyl, MCPA-olamine, MCPA-potassium, MCPA-sodium, MCPA-thioethyl, MCPA-trolamine, MCPB, MCPB-ethyl, MCPB-methyl, MCPB-sodium, mecoprop, mecoprop-2-ethylhexyl, mecoprop-dimethylammonium, mecoprop-diolamine, mecoprop-ethadyl, mecoprop-isoctyl, mecoprop-methyl, mecoprop-P, mecoprop-P-dimethylammonium, mecoprop-P-isobutyl, mecoprop-potassium, mecoprop-P-potassium, mecoprop-sodium, mecoprop-trolamine, medinoterb, medinoterb acetate, mefenacet, mefluidide, mefluidide-diolamine, mefluidide-potassium, mesoprazine, mesosulfuron, mesosulfuron-methyl, metam, metam-ammonium, metamifop, metamitron, metam-potassium, metam-sodium, metazachlor, metazosulfuron, metflurazon, methabenzthiazuron, methalpropalin, methazole, methiobencarb, methiozolin, methiuron, methometon, methoprotryne, methyl bromide, methyl isothiocyanate, methyldymron, metobenzuron, metolachlor, metosulam, metoxuron, metribuzin, metsulfuron, metsulfuron-methyl, molinate, monalide, monisouron, monochloroacetic acid, monolinuron, monuron, monuron TCA, morfamquat, morfamquat dichloride, MSMA, naproanilide, napropamide, naptalam, naptalam-sodium, neburon, nicosulfuron, nipyraclofen, nitralin, nitrofen, nitrofluorfen, norflurazon, noruron, OCH, orbencarb, ortho-dichlorobenzene, orthosulfamuron, oryzalin, oxadiargyl, oxadiazon, oxapyrazon, oxapyrazon-dimolamine, oxapyrazon-sodium, oxasulfuron, oxaziclomefone, parafluron, paraquat, paraquat dichloride, paraquat dimetilsulfate, pebulate, pelargonic acid, pendimethalin, penoxsulam, pentachlorophenol, pentanochlor, pentoxazone, perfluidone, pethoxamid, phenisopham, phenmedipham, phenmedipham-ethyl, phenobenzuron, phenylmercury acetate, picloram, picloram-2-ethylhexyl, picloram-isoctyl, picloram-methyl, picloram-olamine, picloram-potassium, picloram-triethylammonium, picloram-tris(2-hydroxypropyl)ammonium, picolinafen, pinoxaden, piperophos, potassium arsenite, potassium azide, potassium cyanate, pretilachlor, primisulfuron, primisulfuron-methyl, procyazine, prodiamine, profluazol, profluralin, profoxydim, proglinazine, proglinazine-ethyl, prometon, prometryn, propachlor, propanil, propaquizafop, propazine, propham, propisochlor, propoxycarbazone, propoxycarbazone-sodium, propyrisulfuron, prosulfalin, prosulfocarb, prosulfuron, proxan, proxan-sodium, prynachlor, pydanon, pyraclonil, pyraflufen, pyraflufen-ethyl, pyrasulfotole, pyrazolynate, pyrazosulfuron, pyrazosulfuron-ethyl, pyrazoxyfen, pyribenzoxim, pyributicarb, pyriclor, pyridafol, pyridate, pyriftalid, pyriminobac, pyriminobac-methyl, pyrimisulfan, pyrithiobac, pyrithiobac-sodium, pyroxasulfone, pyroxsulam, quinclorac, quinmerac, quinoclamine, quinonamid, quizalofop, quizalofop-ethyl, quizalofop-P, quizalofop-P-ethyl, quizalofop-P-tefuryl, rhodethanil, rimsulfuron, saflufenacil, sebuthylazine, secbumeton, sethoxydim, siduron, simazine, simeton, simetryn, SMA, S-metolachlor, sodium arsenite, sodium azide, sodium chlorate, sulfallate, sulfentrazone, sulfometuron, sulfometuron-methyl, sulfosulfuron, sulfuric acid, sulglycapin, swep, TCA, TCA-ammonium, TCA-calcium, TCA-ethadyl, TCA-magnesium, TCA-sodium, tebutam, tebuthiuron, tefuryltrione, tepraloxydim, terbacil, terbucarb, terbuchlor, terbumeton, terbuthylazine, terbutryn, tetrafluron, thenylchlor, thiazafluron, thiazopyr, thidiazimin, thidiazuron, thiencarbazone, thiencarbazone-methyl, thifensulfuron, thifensulfuron-methyl, thiobencarb, tiocarbazil, tioclorim, topramezone, tralkoxydim, tri-allate, triasulfuron, triaziflam, tribenuron, tribenuron-methyl, tricamba, triclopyr, triclopyr-butotyl, triclopyr-ethyl, triclopyr-triethylammonium, tridiphane, trietazine, trifloxysulfuron, trifloxysulfuron-sodium, trifluralin, triflusulfuron, triflusulfuron-methyl, trifop, trifop-methyl, trifopsime, trihydroxytriazine, trimeturon, tripropindan, tritac, tritosulfuron, vernolate, or xylachlor; and wherein the herbicide safener is selected from benoxacor, cloquintocet-mexyl, cyprosulfamide, dichlormid, fenchlorazole-ethyl, fenclorim, fluxofenim, furilazole and the corresponding R isomer, isoxadifen-ethyl, mefenpyr-diethyl, oxabetrinil, N-isopropyl-4-(2-methoxy-benzoylsulfamoyl)-benzamide, and N-(2-methoxybenzoyl)-4-[methylaminocarbonyl)amino]benzenesulfonamide.

15. The combination according to claim 1 comprising 35%-40% of the diphenylether herbicide and 2%-5% triketone herbicide.

16. An herbicidal composition, comprising:
a triketone herbicide selected from 2-[4-(methylsulfonyl)-2-nitrobenzoyl]cyclohexane-1,3-dione, 2-[2-nitro-4-(trifluoromethyl)benzoyl]cyclohexane-1,3-dione, 2-(2-chloro-4-methylsulfonylbenzoyl)cyclohexane-1,3-dione, or 2-[2-chloro-4-methylsulfonyl-3-(2,2,2-trifluoroethoxymethyl)benzoyl]cyclohexane-1,3-dione; and
a diphenylether herbicide selected from 5-[2-chloro-4-(trifluoromethyl)phenoxy]-2-nitrobenzoic acid, 5-[2-chloro-4-(trifluoromethyl)phenoxy]-N-methylsulfonyl-2-nitrobenzamide, -ethoxy-1-oxopropan-2-yl) 5-[2-chloro-4-(trifluoromethyl)phenoxy]-2-nitrobenzoate, and 2-chloro-4-(trifluoromethyl)phenyl 3-ethoxy-4-nitrophenyl ether.

17. An aqueous herbicidal premix concentrate composition comprising 1% to 10% mesotrione and 30% to 40% oxyfluorfen.

18. The composition according to claim 17, wherein the composition is a concentrate or tank mix consisting essentially of mesotrione and oxyfluorfen.

19. The composition according to claim 17, comprising, by weight percent:
4%-5% mesotrione;
35%-38% oxyfluorfen;
3% surfactant;
12% freeze/thaw agent;
0.2% defoaming agent;
0.15% rheology agent; and
0.15% antimicrobial agent.

20. A method, comprising applying a combination according to claim 1 to a locus where undesired vegetation is present or may be present.

21. The method according to claim 20 comprising applying a premix concentrate or a tank mix composition comprising (1) mesotrione, and (2) oxyfluorofen.

22. The method according to claim 21 wherein the premix or tank mix consists essentially of (1) mesotrione, and (2) oxyfluorofen.

23. A method, comprising forming a premix concentrate or a tank mix comprising an effective amount of (1) a triketone herbicide, and (2) a diphenylether herbicide.

24. The method according to claim 23 wherein the premix concentrate or tank mix comprises (1) mesotrione, and (2) oxyfluorfen.

25. The method according to claim 23 wherein the premix concentrate comprises an aqueous composition comprising oxyfluorfen, mesotrione, a surfactant, a freeze/thaw agent, a defoaming agent, a rheology agent, and an antimicrobial agent.
